(19) United States
(12) Patent Application Publication
(10) Pub. No.: US 2026/0098940 A1
(43) Pub. Date: Apr. 9, 2026

(54) METHODS AND SYSTEMS FOR LOCATING TARGETS AND DEVICE DOCKING

(71) Applicant: ZHEJIANG HUARAY TECHNOLOGY CO., LTD., Hangzhou (CN)

(72) Inventors: Hui LIN, Hangzhou (CN); Wei LU, Hangzhou (CN); Lizhi HU, Hangzhou (CN); Xiang LI, Hangzhou (CN)

(73) Assignee: ZHEJIANG HUARAY TECHNOLOGY CO., LTD., Hangzhou (CN)

(21) Appl. No.: 19/417,424

(22) Filed: Dec. 12, 2025

Related U.S. Application Data
(63) Continuation of application No. PCT/CN2024/102405, filed on Jun. 28, 2024.

(30) Foreign Application Priority Data
Jun. 30, 2023 (CN) 202310800884.8

(51) Int. Cl. G01S 7/48; G01S 17/08; G01S 17/89; G05D 1/661; G05D 109/10; G05D 111/10

(52) U.S. Cl. CPC G01S 7/4802; G01S 17/08; G01S 17/89; G05D 1/661; G05D 2109/10; G05D 2111/17

(57) ABSTRACT

The present disclosure provides a method for locating a target. The target includes at least three reflection regions. The at least three reflection regions include at least two first reflection regions distributed at intervals and at least one second reflection region. The method comprises: obtaining first point cloud data generated by scanning the target by a laser scanning device; determining, based on reflection intensities of a plurality of first data points, point clouds of at least three first target reflection regions of the at least three reflection regions from the first point cloud data; determining, based on the point clouds of the at least three first target reflection regions, a laser reflection angle of each of the at least three first target reflection regions; and determining, based on the laser reflection angle of each of the at least three first target reflection regions, first location information of the target.

### CROSS-REFERENCE TO RELATED APPLICATIONS

The present application is a continuation of International Application No. PCT/CN2024/102405, filed on Jun. 28, 2024, which claims priority to Chinese Application No. 202310800884.8, filed on Jun. 30, 2023, the contents of which are hereby incorporated by reference to its entirety.

### TECHNICAL FIELD

The present disclosure relates to the field of target localization, and in particular to a method and a system for locating a target and device docking.

### BACKGROUND

In the fields of warehousing, logistics, and manufacturing, autonomous mobile devices (e.g., an autonomous mobile robot (AMR)) are of great application significance, which are capable of navigating autonomously in complex environments without human control or preset paths, sensing the environment through high-precision sensors (e.g., a laser sensor), and planning the paths to complete a docking process with a docking target (e.g., a charging pile, a stop, a shelf, etc.), such as docking of a production line material truck with a conveyor belt, docking of a forklift pallet with a hoists, automatic charging of an autonomous mobile device, etc.

In some cases, the docking of the autonomous mobile device with a docking target can be accomplished through target localization, i.e., a position and an attitude of the docking target relative to the autonomous mobile device are identified in the docking process, and then a path is dynamically planned to complete the docking. Therefore, it is desirable to provide a method and a system to efficiently and accurately identify the docking target.

### SUMMARY

One of the embodiments of the present disclosure provides a method for locating a target implemented on a device including at least one processing device and at least one storage device. The target may include at least three reflection regions. The at least three reflection regions may include at least two first reflection regions distributed at intervals and at least one second reflection region. A region between every two adjacent first reflection regions of the at least two first reflection regions may be the second reflection region. Reflective properties of the at least two first reflection regions may be different from a reflective property of the at least one second reflection region. The method may comprise: obtaining first point cloud data generated by scanning the target by a laser scanning device, the first point cloud data including a plurality of first data points; determining, based on reflection intensities of the plurality of first data points, point clouds of at least three first target reflection regions of the at least three reflection regions from the first point cloud data; determining, based on the point clouds of the at least three first target reflection regions, a laser reflection angle of each of the at least three first target reflection regions; and determining, based on the laser reflection angle of each of the at least three first target reflection regions, first location information of the target.

One of the embodiments of the present disclosure provides a method for device docking implemented on a device including at least one processing device and at least one storage device, comprising: controlling a device to move to a target position for docking, including: determining initial location information of a target; determining adjusted location information by adjusting, based on a compensation value, the initial location information; determining a docking position based on the compensated location information; generating a planned path with a current position of the device as a starting point and the docking position as an end point; and controlling the device to move based on the planned path.

One of the embodiments of the present disclosure provides a system for locating a target, implemented on a device including at least one processing device and at least one storage device. The target may include at least three reflection regions. The at least three reflection regions may include at least two first reflection regions distributed at intervals and at least one second reflection region. A region between every two adjacent first reflection regions may be the second reflection region. Reflective properties of the at least two first reflection regions may be different from a reflective property of the at least one second reflection region. The system may comprise a first acquisition module configured to obtain first point cloud data generated by scanning the target by a laser scanning device, the first point cloud data including a plurality of first data points; a selection module configured to determine, based on reflection intensities of the plurality of first data points, point clouds of at least three first target reflection regions of the at least three reflection regions from the first point cloud data; a first determination module configured to determine, based on the point clouds of the at least three first target reflection regions, a laser reflection angle of each of the at least three first target reflection regions; and a second determination module configured to determine, based on the laser reflection angle of each of the at least three first target reflection regions, first location information of the target.

One of the embodiments of the present disclosure provides a non-transitory computer readable medium, comprising at least one set of instructions for locating a target. The target may include at least three reflection regions. The at least three reflection regions may include at least two first reflection regions distributed at intervals and at least one second reflection region. A region between every two adjacent first reflection regions of the at least two first reflection regions may be the second reflection region. Reflective properties of the at least two first reflection regions may be different from a reflective property of the at least one second reflection region. When executed by one or more processors of a computing device, the at least one set of instructions may cause the computing device to perform a method. The method may comprise: obtaining first point cloud data generated by scanning the target by a laser scanning device, the first point cloud data including a plurality of first data points; determining, based on reflection intensities of the plurality of first data points, point clouds of at least three first target reflection regions of the at least three reflection regions from the first point cloud data; determining, based on the point clouds of the at least three first target reflection regions, a laser reflection angle of each of the at least three first target reflection regions; and determining, based on the laser reflection angle of each of the at least three first target reflection regions, first location information of the target.

One of the embodiments of the present disclosure provides a system for device docking, comprising: at least one storage device including a set of instructions; and at least one processor in communication with the at least one storage device. When executing the set of instructions, the at least one processor may be directed to perform operations including: controlling a device to move to a target position for docking, including: determining initial location information of a target; determining adjusted location information by adjusting, based on a compensation value, the initial location information; determining a docking position based on the compensated location information; generating a planned path with a current position of the device as a starting point and the docking position as an end point; and controlling the device to move based on the planned path.

One of the embodiments of the present disclosure provides a non-transitory computer readable medium, comprising at least one set of instructions for device docking. When executed by one or more processors of a computing device, the at least one set of instructions may cause the computing device to perform a method. The method may comprise: controlling a device to move to a target position for docking, including: determining initial location information of a target; determining adjusted location information by adjusting, based on a compensation value, the initial location information; determining a docking position based on the compensated location information; generating a planned path with a current position of the device as a starting point and the docking position as an end point; and controlling the device to move based on the planned path.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an application scenario of a system for locating a target according to some embodiments of the present disclosure;

FIG. 2 is a flowchart illustrating an exemplary process for locating a target according to some embodiments of the present disclosure;

FIG. 3 is a schematic diagram illustrating an exemplary target according to some embodiments of the present disclosure;

FIG. 4 is a schematic diagram illustrating an exemplary process for determining first location information according to some embodiments of the present disclosure;

FIG. 5 is a schematic diagram illustrating an exemplary process for locating a target according to some embodiments of the present disclosure;

FIG. 6 is a schematic diagram illustrating an exemplary distribution of point clouds according to some embodiments of the present disclosure;

FIG. 7 is a flowchart illustrating an exemplary process for device docking according to some embodiments of the present disclosure;

FIG. 8 is a schematic diagram illustrating exemplary positions of an identification starting point and an identification end point according to some embodiments of the present disclosure;

FIG. 9 is a block diagram illustrating an exemplary system for locating a target according to some embodiments of the present disclosure;

FIG. 10 is a block diagram illustrating an exemplary system for device docking according to some embodiments of the present disclosure;

FIG. 11 is a flowchart illustrating an exemplary process for locating a target according to some embodiments of the present disclosure;

FIG. 12 is a flowchart illustrating an exemplary process for device docking according to some embodiments of the present disclosure;

FIG. 13 is a flowchart illustrating an exemplary process for device docking according to some embodiments of the present disclosure;

FIG. 14 is structural schematic diagram illustrating an exemplary electronic device according to some embodiments of the present disclosure; and

FIG. 15 is a structural schematic diagram illustrating an exemplary non-transitory computer readable storage medium according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person having ordinary skills in the art to apply the present disclosure to other similar scenarios in accordance with these drawings without creative labor. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, parts, portions or assemblies of different levels. However, the words may be replaced by other expressions if other words can achieve the same purpose.

As indicated in the disclosure and claims, the terms “a”, “an”, and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The flowchart is used in the present disclosure to illustrate the operations performed by the system according to the embodiments of the present disclosure. It should be understood that the preceding or following operations are not necessarily performed in the exact order. Instead, various steps may be processed in reverse order or simultaneously. Meanwhile, other operations may be added to these procedures, or a certain step or steps may be removed from these procedures.

An autonomous mobile device typically needs to be docked with a docking target such as a shelf, a charging pile, a docking station, etc. when performing a task such as transporting goods, charging autonomously, etc. The autonomous mobile device typically observes the environment and plans a path through sensors such as a laser scanning device, etc., and then moves to a target position at a preset distance and orientation from a target workstation for docking. However, during a docking process, how to identify the docking target is a key concern.

In the related art, a manner of posting reflective stripes at both ends of the docking target as references may be used, and coordinates of the docking target may be calculated by a laser radar (LiDAR) by capturing low-brightness point clouds of the reflective stripes. However, due to the ranging characteristics of the LiDAR, i.e., the ranging error gradually increases at a close distance, when the autonomous mobile device is close to the docking target, the accuracy of identification decreases significantly due to the proximity ranging error of the LiDAR, thus affecting the docking accuracy. In addition, after the autonomous mobile device is in contact or close to contact with the docking target, due to the relatively large proximity ranging error of the LIDAR, it is not possible to measure an actual docking error, which makes the autonomous mobile device unable to perform feedback and adjustment based on an actual docking effect, leading to a relatively low breadth and reliability of such docking manner in practical applications.

In view of the foregoing, the present disclosure provides a method and a system for locating a target and device docking. A target including at least three reflection regions are provided on the docking target, and the target can be identified by taking advantage of the property that the closer the distance, the higher the measurement accuracy of the laser reflection angle for the identification of the target, so that the positioning accuracy of the target in close proximity can be improved. Furthermore, after the docking is completed, an error value of the docking is determined and the next target identification is compensated based on the error values of one or more previous dockings, thereby further improving the docking accuracy.

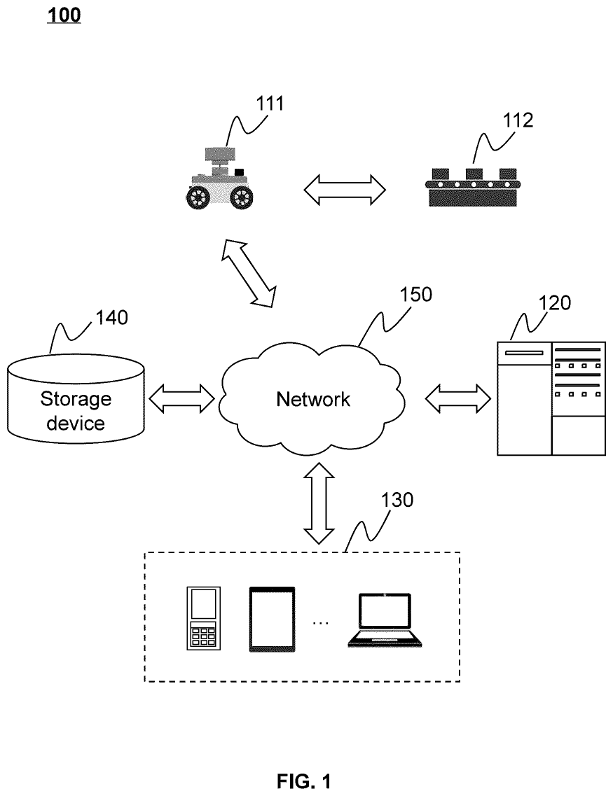

FIG. 1 is a schematic diagram illustrating an application scenario of a system for locating a target according to some embodiments of the present disclosure.

As shown in FIG. 1, a system 100 for locating a target may include a device 111, a target 112, a processor 120, a terminal device 130, a storage device 140, and a network 150.

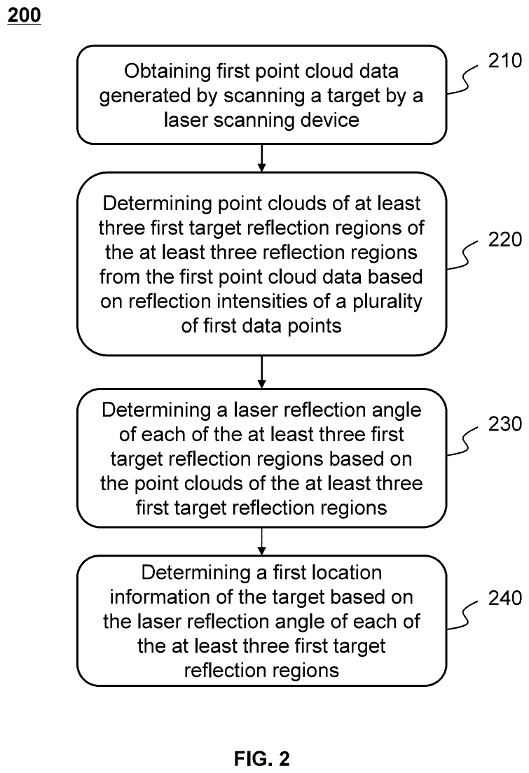

The device 111 refers to an apparatus/device that can move autonomously. For example, the device 111 may include an autonomous mobile robot (AMR), an automated guided vehicle (AGV), an unmanned forklift, a cleaning robot, or the like. In some embodiments of the present disclosure, the device 111 may also be referred to as an autonomous mobile device. In some embodiments, a laser scanning device may be provided on the device 111, and the laser scanning device may scan the target 112 to obtain point cloud data. More descriptions regarding scanning the target 112 to obtain the point cloud data may be found in the following descriptions (e.g., descriptions in connection with FIG. 2, etc.).

The target 112 may be provided on a docking target. The device 111 may scan the target 112 through the laser scanning device and locate the target 112. The device 111 may dock with the docking target based on the locating result of the target 112. For example, the docking target may include a charging pile, a docking station, a shelf, etc.

The processor 120 may be configured to process data and/or information obtained from the device 111, the terminal device 130, the storage device 140, or other components of the system 100. In some embodiments, the processor 120 may be configured to obtain, from the device 111, first point cloud data generated by scanning the target 112 by the laser scanning device, the first point cloud data including a plurality of first data points; determine, based on reflection intensities of the plurality of first data points, point clouds of at least three first target reflection regions of at least three reflection regions from the first point cloud data; determine, based on the point clouds of the at least three first target reflection regions, a laser reflection angle of each of the at least three first target reflection regions; and determine, based on the laser reflection angle of each of the at least three first target reflection regions, first location information of the target. More descriptions may be found in the following descriptions (e.g., descriptions in connection with FIG. 2, etc.).

In some embodiments, the processor 120 may be local or remote. For example, the processor 120 may access information and/or data from the device 111, the terminal device 130, and/or the storage device 140 via the network 150. In some embodiments, the processor 120 may be a portion of the device 111.

In some embodiments, the processor 120 may include one or more processing engines (e.g., a single-chip processing engine or a multi-chip processing engine).

The terminal device 130 may be a user-operated terminal. The terminal device 130 may be configured to provide functional components related to user interaction and realize user interaction functions (e.g., providing or displaying information and data to a user). The user refers to a manager/operator, etc., of the device 111. Merely by way of example, the terminal device 130 may be one of a mobile device, a tablet computer, a laptop computer, a desktop computer, or the like, or any combination thereof, among other devices having input and/or output functions. In some embodiments, the terminal device 130 may be integrated in the device 111, i.e., the terminal device 130 and the device 111 may perform all functions as a whole. In some embodiments, the user may use the terminal device 130 to control the device 111 to dock with the docking target, etc.

The storage device 140 may be configured to store data, instructions, and/or any other information. In some embodiments, the storage device 140 may store data obtained from the device 111 and/or the processor 120, such as the first point cloud data generated by scanning the target 112 by the laser scanning device, etc. In some embodiments, the storage device 140 may include one or more storage components. Each of the one or more storage components may be a stand-alone device or may be a portion of another device. In some embodiments, the storage device 140 may include a random access memory (RAM), a read-only memory (ROM), a mass storage, a removable memory, a volatile read/write memory, or the like, or any combination thereof. In some embodiments, said storage device 140 may be implemented on a cloud platform.

The network 150 may include any suitable network capable of facilitating the exchange of information and/or data. In some embodiments, at least one component (e.g., the device 111, the processor 120, the terminal device 130, and the storage device 140) of the system 100 may exchange information and/or data with at least one other component of the application scenario 100 of the system via the network 150. For example, the processor 120 may obtain the first point cloud data, or the like, from the device 111 via the network 150.

It should be noted that the application scenario 100 of the system for locating the target is provided for illustrative purposes only, and is not intended to limit the scope of the present disclosure. For a person of ordinary skill in the art, a variety of modifications or variations may be made in accordance with the description of the present disclosure. For example, the application scenario 100 of the system for locating the target may also include a database. As another example, the application scenario 100 of the system for locating the target may implement similar or different functions on other devices. However, these changes and modifications do not depart from the scope of the present disclosure.

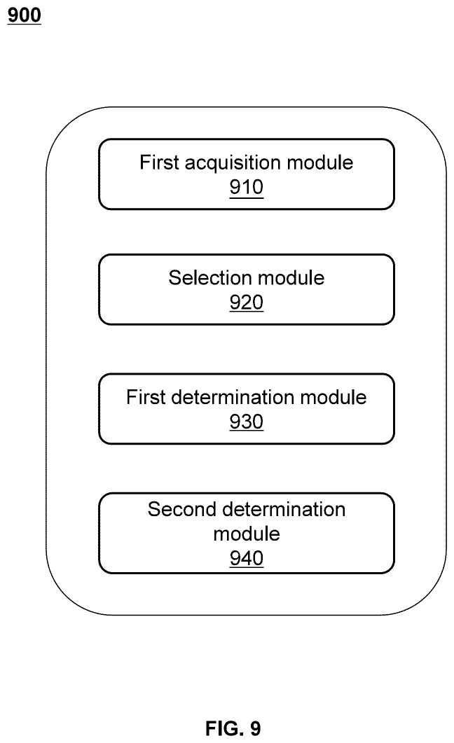

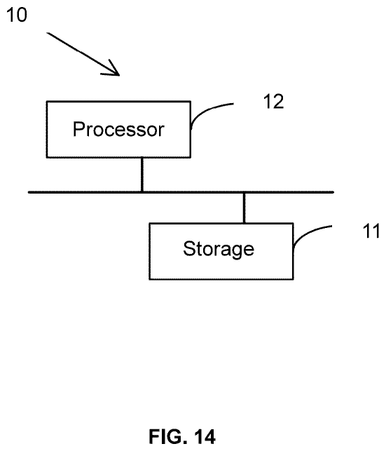

FIG. 2 is a flowchart illustrating an exemplary process for locating a target according to some embodiments of the present disclosure. In some embodiments, the process 200 may be implemented in the system 100 illustrated in FIG. 1. For example, the process 200 may be stored in a storage medium (e.g., the storage device 140, a storage 11 illustrated in FIG. 14, etc.) as a form of instructions, and can be invoked and/or executed by a processing device (e.g., the processor 120, a processor 12 illustrated in FIG. 14, or one or more modules illustrated in FIG. 9). The operations of the illustrated process 200 presented below are intended to be illustrative. In some embodiments, the process 200 may be accomplished with one or more additional operations not described, and/or without one or more of the operations discussed. Additionally, the order in which the operations of the process 200 as illustrated in FIG. 2 and described below is not intended to be limiting. In some embodiments, the process 200 may be performed by the device 111, the processor 120, or the terminal device 130. For the purpose of illustration, in the following descriptions, the process 200 performed by the processor 120 is described as an example.

In 210, the processor 120 may obtain first point cloud data generated by scanning a target by a laser scanning device.

The laser scanning device refers to a device capable of utilizing a laser beam to measure a distance and a position of an object. For example, the laser scanning device is capable of scanning objects and obstacles in an environment around the device 111 (e.g., within a certain distance from the device 111) to measure positions and distances of the objects and the obstacles by emitting laser beams and receiving reflected signals of the laser beams. In some embodiments, the laser scanning device may be provided on the device 111. For example, the laser scanning device may be provided at any suitable position of the device 111, e.g., in front of, above, on a left or right side of the device 111.

The target (e.g., the target 112) may be provided on a docking target. The device 111 may scan the target 112 through the laser scanning device and locate the target 112. The device 111 may dock with the docking target based on the locating result of the target 112. For example, the docking target may include a charging pile, a docking station, a shelf, etc.

In some embodiments, the target may include at least three reflection regions. The at least three reflection regions refer to regions that are capable of reflecting the laser beams emitted by the laser scanning device.

In some embodiments, the at least three reflection regions may include at least two first reflection regions distributed at intervals and at least one second reflection region. A region between every two adjacent first reflection regions of the at least two first reflection regions may be the second reflection region. Reflective properties of the at least two first reflection regions may be different from a reflective property of the at least one second reflection region.

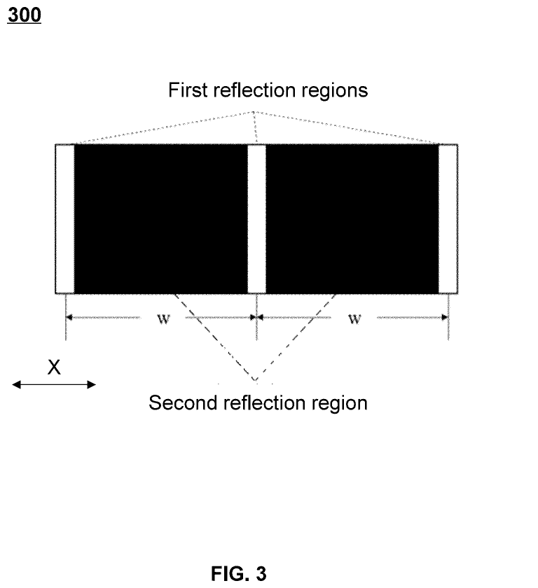

Merely by way of example, FIG. 3 is a schematic diagram illustrating an exemplary target according to some embodiments of the present disclosure. The target 112 may be configured based on the target 300 illustrated in FIG. 3. As shown in FIG. 3, the target 300 may include three first reflection regions and two second reflection regions.

In some embodiments, a distance between every two adjacent first reflection regions and/o a distance between every two adjacent second reflection regions may be known. In some embodiments, the first reflection regions may be equally spaced. For example, as shown in FIG. 3, a distance between any two adjacent first reflection regions may be w. In some embodiments, the first reflection regions may also be unequally spaced. For example, a distance between any two adjacent first reflection regions may be different. A distance between two reflection regions refers to a distance between centerlines of the two reflection regions, or a distance between opposite sides of the two reflection regions. For example, as shown in FIG. 3, a distance between two adjacent first reflection regions refers to a distance w between centerlines of the two first reflection regions. In some embodiments, the second reflection regions may be equally or unequally spaced. For example, a distance between any two adjacent second reflection regions may be the same or different. A width of a reflection region refers to a length of a side of the reflection region along a direction (e.g., X direction in FIG. 3) where the reflection regions of the target arranged. In some embodiments, the widths of the first reflection regions may be the same or different. The widths of the second reflection regions may be the same or different. The widths of the first reflection regions may be the same with or different from the widths of the second reflection regions.

Merely by way of example, the first reflection regions of the target may be equally spaced. The second reflection regions of the target may be equally spaced. The widths of the first reflection regions of the target may be the same. The widths of the second reflection regions of the target may be the same. The widths of the first reflection regions of the target may be shorter than the widths of the second reflection regions of the target. In some embodiments, reflective properties of the at least two first reflection regions may be different from a reflective property of the least one second reflection region. The reflective property indicates a reflective intensity of the reflection region to the laser beams emitted by the laser scanning device. The greater the reflection intensity, the greater reflective property. In some embodiments, the reflection intensity may be determined by a ratio of a reflected laser power value received by a receiver of the laser scanning device to a laser power value transmitted by a transmitter of the laser scanning device. The greater the ratio, the greater the reflection intensity.

In some embodiments, the reflective properties of the at least two first reflection regions may be greater than the reflective property of the at least one second reflection region, i.e., the at least two first reflection regions may be high reflection regions, and the at least one second reflection region may be a low reflection region.

In some embodiments, the reflective properties of the at least two first reflection regions may be weaker than the reflective property of the at least one second reflection region, i.e., the at least two first reflection regions may be low reflection regions, and the at least one second reflection region may be a high reflection region.

There is no limitation on the manner in which the high and low reflection regions are formed. For example, one or more reflective stripes may be attached to the target. A region where the one or more reflective stripes are located may be referred to as the high reflection region, whereas a region on the target where the one or more reflective stripes are not attached may be referred to as the low reflection region. As another example, a region of the target where a reflective coating is provided may be referred to as the high reflection region of the target, and a region of the target where a matte material is provided may be referred to as the lower reflection region of the target.

In some embodiments, the at least three reflection regions of the target may be located, or substantially located, on the same plane. For example, the at least two first reflection regions and the at least one second reflection region may be disposed on one surface of the target, and the surface may be a plane, or tend to be a plane.

In some embodiments, the at least three reflection regions of the target may be disposed on a reference object to form the target, and the target may be disposed on a docking target. For example, the target may be hung in front of the docking target, so that the device 111 may determine location information of the target by the at least three reflection regions on the reference object. Merely by way of example, a plurality of reflective stripes may be attached to a flat plate-like reference object so that the at least three reflection regions may be formed on the reference object. As another example, a plurality of reflective stripes may be directly attached to the docking target so that the at least three reflection regions may be directly formed on the docking target.

The first point cloud data refers to a dataset obtained after the laser scanning device performs a laser scan in a certain range (e.g., a range of 45°, 60°, 90°, 180°, 360°, etc.) to scan the target. In some embodiments, the first point cloud data may include a plurality of first data points. The plurality of first data points may be arranged in clockwise or counterclockwise order in the first point cloud data.

A laser beam emitted from the laser scanning device hits a location of an object, the laser beam may be reflected by the location of the object. The plurality of first data points refer to data information recorded in the form of points for each reflection laser beam during the laser scan. A first data point may include information such as coordinate information of the location of the object, a reflection intensity of the reflection laser beam, a reflection angle of the reflection laser beam, a distance between the laser scanning device and the location of the object, a period from a time when the laser scanning device emits the laser beam to a time when the laser scanning device receives the reflection laser beam, or the like.

In some embodiments, the first point cloud data may be obtained by scanning the at least three reflection regions (e.g., the at least two first reflection regions and the at least one second reflection region) of the target by the laser scanning device.

In some embodiments, in order to enable the laser scanning device to scan the at least three reflection regions of the target, a height of the at least one second reflection region/the at least two first reflection regions from the ground may correspond to a height of a laser plane (e.g., the laser plane may be parallel to the ground and laser beams emitted by the laser scanning device may be located in the laser plane) of the laser scanning device from the ground, i.e., height ranges of the at least one second reflection region and the at least two first reflection regions may cover a scanning range of the laser scanning device, to ensure that the laser beams emitted by the laser scanning device can be irradiated on the at least two first reflection regions and the at least one second reflection region. In some embodiments, the heights of the at least two first reflection regions and the at least one second reflection region from the ground may be adjusted accordingly based on a laser flatness and a ground undulation.

In 220, the processor 120 may determine point clouds of at least three first target reflection regions of the at least three reflection regions from the first point cloud data based on reflection intensities of a plurality of first data points. The at least three first target reflection regions may include at least three first reflection regions. The at least three first target reflection regions may include at least three second reflection regions. The at least three first target reflection regions may include at least two first reflection regions and at least one second reflection region. The at least three first target reflection regions may include at least two second reflection regions and at least one first reflection region.

The point cloud of a reflection region refers to a set of first data points corresponding to the reflection region. For example, the point clouds of the at least two first reflection regions may include first data points corresponding to the at least two first reflection regions.

The first point cloud data may be obtained by scanning the at least two first reflection regions and the at least one second reflection region of the target by the laser scanning device. The obtained first point cloud data may include the point cloud of the at least two first reflection regions and the point cloud of the at least one second reflection region. Because the reflective properties of the at least two first reflection regions are different from the reflective property of the at least one second reflection region, the processor 120 may distinguish the point cloud of the at least two first reflection regions and the point cloud of the at least one second reflection region based on the reflection intensities of the plurality of first data points in the first point cloud data.

In some embodiments, the processor 120 may obtain an intensity threshold, determine, based on the intensity threshold and the reflection intensities of the plurality of first data points, at least one first candidate point set and/or at least one second candidate point set from the first point cloud data, and determine, based on the at least one first candidate point set and/or the at least one second candidate point set, the point clouds of the at least three first target reflection regions. The at least one first candidate point set may be related to the at least two first reflection regions, and the at least one second candidate point set may be related to the at least one second reflection region.

The intensity threshold may be a preset value. The intensity threshold may be set according to an actual situation such as intensities of the laser beams emitted by the laser scanning device, the reflective properties of the at least two first reflection regions, the reflective property of the at least one second reflection region, etc. For example, the greater the intensities of the laser beams emitted by the laser scanning device and the better the reflective properties of the at least two first reflection regions and/or the reflective property of the at least one second reflection region, the greater the intensity threshold.

In some embodiments, the processor 120 may determine the at least one first candidate set of and/or the at least one second candidate point set from the first point cloud data based on the intensity threshold and the reflection intensities of the plurality of first data points.

The processor 120 may determine a set of first data points among the plurality of first data points of which the reflection intensities are greater than the intensity threshold as a first point set. Alternatively or additionally, the processor 120 may determine a set of first data points among the plurality of first data points of which the reflection intensities are less than or equal to the intensity threshold as a second point set.

It should be noted that, since the target may include a plurality of first reflection regions and a plurality of second reflection regions, it is necessary to process the first point set and/or the second point set to determine the point clouds of the first reflection regions and/or the second reflection regions.

In some embodiments, the processor 120 may process the first point set and/or the second point set to determine at least one first candidate point set and/or at least one second candidate point set; and determine, based on the at least one first candidate point set and/or the at least one second candidate point set, the point clouds of the at least three first target reflection regions.

In some embodiments, the processor 120 may divide the first point set into the at least one first candidate point set.

In some embodiments, the processor 120 may perform cluster analysis on the first point set to obtain the at least one first candidate point set. Further, the processor 120 may perform cluster analysis on the first data points in the first point set based on distances (e.g., Euclidean distances) between the first data points in the at least one first point set, and determine the first data points belonging to the same cluster as the same first candidate point set.

In some embodiments, for a first data point A belonging to the first point set, there are first data point B and first data point C adjacent to first data point A, where first data point B is in a first direction of first data point A, first data point C is in a second direction of first data point A, and the first direction is opposite to the second direction. If first data points B and C belong to the first point set, first data points A, B, and C may be classified as the same first candidate point set. If first data point B belongs to the first point set and first data point C belongs to the second point set, first data points A and B may be classified as the same first candidate point set, and the first data point that is closest to first data point A in the second direction and belongs to the first point set may be classified as a different first candidate point set from the first candidate point set corresponding to first data point A.

In some embodiments, the processor 120 may determine the at least one second candidate point set in a similar manner as determining the at least one first candidate point set, which is not repeated here.

In some embodiments, the laser scanning device, while scanning the reflection regions of the target, may also scan other objects around the laser scanning device, and/or similar reflection regions may also be disposed in places other than the docking target, resulting in that a count of the at least one first candidate point set is not equal to a count of the at least two first reflection regions and/or a count of the at least one second candidate point set is not equal to a count of the at least one second reflection region.

In some embodiments, when the count of the at least one first candidate point set is equal to the count of the at least two first reflection regions and/or the count of the at least one second candidate point set is equal to the count of the at least one second reflection region, the processor 120 may select at least three candidate point sets from the at least one first candidate point set and/or the at least one second candidate point set as the point clouds of the at least three first target reflection regions.

In some embodiments, in response to determining that the count of the at least one first candidate point set is not equal to the count of the at least two first reflection regions and/or the count of the at least one second candidate point set is not equal to the count of the at least one second reflection region, the processor 120 may determine, based on a preset distance range and/or a present angle range, the point clouds of the at least three first target reflection regions from the at least one first candidate point set and/or the at least one second candidate point set. For example, the first candidate point set and/or the second candidate point set that satisfies the preset distance range and/or the present angle range may be determined as corresponding to the at least three reflection regions of the target. The processor 120 may select, as the at least three first target reflection regions, at least three point sets from the first candidate point set and/or the second candidate point set that satisfies the preset distance range and/or the present angle range.

The preset distance range refers to a preset range of distances between the target and the laser scanning device. For example, the preset distance range may be a range of distances between the target and the laser scanning device during historical docking processes.

The preset angle range refers to a range of laser reflection angles of the at least three reflection regions of the target. The preset angle range may be determined based on the range of the laser reflection angles of the at least three first target reflection regions. For example, the preset angle range may be a range of laser reflection angles of the at least two first reflection regions and/or the at least one second reflection region during the historical docking processes.

In some embodiments, the processor 120 may obtain an initial position information of the target in advance. The processor 120 may determine the preset distance range and the preset angle range based on the initial position information and the current position information of the device 111. For example, based on the initial position information, the current position information of the device 111 and the width of the target, a range of laser reflection angles of the at least three reflection regions of the target may be determined.

In some embodiments, since a distance between every two reflection regions of the target is known, the processor 120 may select, based on the distance between any two reflection regions of the target, the point clouds corresponding to the reflection regions of the target from the at least one first candidate point set and/or the at least one second candidate point set.

In some embodiments, the at least three first target reflection regions may include at least three first reflection regions. For example, the processor 120 may determine the point clouds of the at least three first reflection regions from the at least one first candidate point set, and the operation for determining the at least one second candidate point set may be omitted.

In some embodiments, when the count of the at least one first candidate point set is equal to the count of the at least two first reflection regions, the processor 120 may select at least three candidate point sets from the at least one first candidate point set to be used as the point clouds of the at least three first target reflection regions.

In some embodiments, when the count of the at least one first candidate point set is not equal to the count of the at least two first reflection regions, the processor 120 may determine the point clouds of the at least three first target reflection regions from the at least one first candidate point set based on the preset distance range and/or the preset angle range. For example, the first candidate point sets that satisfy the preset distance range and/or the present angle range may be determined as corresponding to the first reflection regions of the target. The processor 120 may select, as the at least three first target reflection regions, at least three first candidate point sets that satisfy the preset distance range and/or the present angle range.

Merely by way of example, the target includes three first reflection regions. The processor 120 identifies four first candidate point sets from the first point cloud data. The processor 120 may extract three of the four first candidate point sets within the preset distance range and/or the preset angle range, and use the extracted three first candidate point sets as the point clouds of the three first reflection regions.

In some embodiments, the at least three first target reflection regions may include at least three second target reflection regions. For example, the processor 120 may determine the point clouds of the at least three second target reflection regions from the at least one second candidate point set, and the operation for determining the at least one first candidate point set may be omitted.

In some embodiments, the at least three first target reflection regions may include at least two first reflection regions and at least one second reflection region between the at least two first reflection regions. In some embodiments, the at least three first target reflection regions may include at least two second reflection regions and at least one first reflection region between the at least two second reflection regions. For example, the processor 120 may select the first reflection regions from the plurality of first candidate point sets and the second reflection regions from the second candidate point sets.

A manner of determining the point clouds of at least three second reflection regions, the at least two first reflection regions and the at least one second reflection region between the at least two first reflection regions, and the at least two second reflection regions and the at least one first reflection regions between the at least two second reflection regions may be similar to a manner of determining the at least three first reflection regions. Detailed descriptions may be found in the related descriptions above.

In 230, the processor 120 may determine a laser reflection angle of each of the at least three first target reflection regions based on the point clouds of the at least three first target reflection regions.

A laser reflection angle of a first data point refers to an angle between a reflected light corresponding to the first data point and the current movement direction of the laser scanning device (e.g., the current movement direction of the device 111).

In some embodiments, the laser reflection angle of a first target reflection regions may be determined based on the laser reflection angle of at least one first data point of the point cloud of the first target reflection region. For example, the processor 120 may determine the laser reflection angle of a central first data point of the point cloud of a first target reflection region as the laser reflection angle of the first target reflection region. As another example, the processor 120 may determine an average value of the laser reflection angles of two first data points respectively located at two edges of the point cloud of a first target reflection region, and determine the average value as the laser reflection angle of the first target reflection region. As still another example, the processor 120 may determine an average value of the laser reflection angles of all of the first data points of the point cloud of a first target reflection region, and determine the average value as the laser reflection angle of the first target reflection region.

In 240, the processor 120 may determine first location information of the target based on the laser reflection angle of each of the at least three first target reflection regions.

The first location information refers to a position and an attitude of the target relative to the autonomous mobile device. In some embodiments, the first location information may be two-dimensional (2D) location information. In some embodiments, the first location information may include coordinates of a point on the target (e.g., a central point or a corner point of the target) in a preset coordinate system with a yaw angle. The preset coordinate system may include a laser coordinate system, a coordinate system of the device 111, a coordinate system of the docking target, a map coordinate system, or the like. Different coordinate systems may be converted into each other by, for example, a coordinate conversion matrix, etc. The yaw angle refers to an angle between a line vertical to a plane where the at least three first target reflection regions are located and a movement direction of the laser scanning device.

The laser coordinate system may be a two-dimensional (2D) coordinate system constructed based on the laser scanning device. For example, an origin of the laser coordinate system may be a central point of the laser scanning device, an x axis of the laser coordinate system may be a movement direction of the laser scanning device, and a y axis of the laser coordinate system may be vertical to the x axis of the laser coordinate system. The x axis and the y axis of the laser coordinate system may define a plane parallel to the ground.

The coordinate system of the device 111 may be a two-dimensional (2D) coordinate system constructed based on the device 111. For example, an origin of the coordinate system of the device 111 may be a central point of the device 111, an x axis of the coordinate system of the device 111 may be a movement direction of the device 111, and a y axis of the coordinate system of the device 111 may be vertical to the x axis of the coordinate system of the device 111. The x axis and the y axis of the coordinate system of the device 111 may define a plane parallel to the ground. As used in the present disclosure, the movement (or the movement direction) of the laser scanning device and the movement (or the movement direction) of the device 111 may be used interchangeably.

The coordinate system of the docking target may be a two-dimensional (2D) coordinate system constructed based on the docking target. For example, an origin of the coordinate system of the docking target may be a central point of the docking target, an x axis of the coordinate system of the docking target may be a front-back direction of the docking target, and a y axis of the coordinate system of the docking target may be vertical to the x axis of the coordinate system of the docking target and may be a right-left direction of the docking target.

An origin of the map coordinate system may be a central point of a region corresponding to the map coordinate system, an x axis of the map coordinate system may be a south-north direction, and a y axis of the map coordinate system may be vertical to the x axis of the map coordinate system and may be a east-west direction.

In some embodiments, the processor 120 may determine, based on the laser reflection angle of each of the at least three first target reflection regions, an angle difference between the laser reflection angles of every two adjacent first target reflection regions; and determine, based on the angle difference and a distance between every two adjacent first target reflection regions, the first location information of the target.

For example, the at least three first target reflection regions may include three first reflection regions. The processor 120 may determine an angle difference between the laser reflection angles of every two adjacent first reflection regions; and determine, based on the angle difference and a distance between every two adjacent first reflection regions, the first location information of the target.

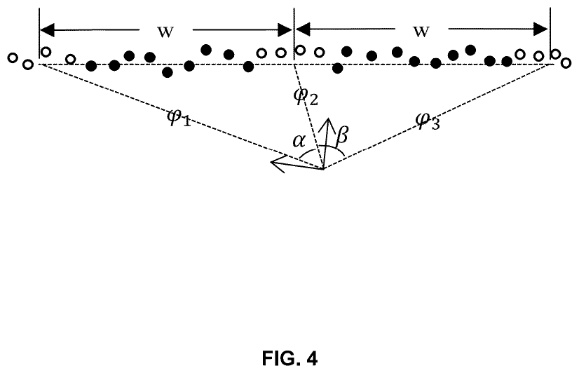

FIG. 4 is a schematic diagram illustrating an exemplary process for determining first location information according to some embodiments of the present disclosure. Operation 240 of the process 200 in FIG. 2 may be performed based on the description in connection with FIG. 4.

As shown in FIG. 4, the target may include three first reflection regions equally distributed and two second reflection regions. The processor 120 may determine the three first reflection regions as the target first reflection regions to determine the first location information of the target. The laser reflection angles of the three first reflection regions may be φ₁, Ω₂, and φ₃, respectively. The angle differences between the laser reflection angles of every two adjacent first reflection regions may be α (e.g., Ω₂−Ω₁) and β (e.g., Ω₃−Ω₂), respectively. Assuming that a distance between centers of two adjacent first reflection regions of the three first reflection regions is w, α, β, and w may be input into formula (1), formula (2), formula (3), formula (4), and formula (5) to determine location information

$${T}_{L}^{f} = [ {x}_{L}^{f} , {y}_{L}^{f} , {θ}_{L}^{f} ]$$

of the laser scanning device relative to the target, and the first location information of the target relative to the laser scanning device may be determined based on formula (6), wherein wherein

$$A = \frac{1}{w} \frac{16 {( sin α )}^{4} + 16 {( sin β )}^{4} - 32 {( sin α )}^{2} {( sin β )}^{2} - {( sin α )}^{4} {( sin β )}^{6} + 8 {( sin α )}^{6} {( sin β )}^{2} - 8 {( sin α )}^{4} {( sin β )}^{4}}{4 {( sin α )}^{4} {( sin β )}^{2} ( {( sin α )}^{2} - {( sin β )}^{2} )} ; \qquad ( 1 )$$

$$B = \frac{w}{4} ( \frac{1}{{( sin β )}^{2}} - \frac{1}{{( sin α )}^{2}} ) ; \qquad ( 2 )$$

$${x}_{L}^{f} = \frac{\sqrt{AB - 1}}{A} ; \qquad ( 3 )$$

$${y}_{L}^{f} = \frac{1}{A} ; \qquad ( 4 )$$

$${θ}_{L}^{f} = {φ}_{2} - {tan}^{- 1} ( \frac{{y}_{L}^{f}}{{x}_{L}^{f}} ) ; \qquad ( 5 )$$

$${T}_{f}^{L} = {( {T}_{L}^{f} )}^{- 1} . \qquad ( 6 )$$

The formulas (1), (2), (3), (4), (5) may be derived using a principle for determining an area of a triangle by multiplying a base by a height of the triable and a principle for determining an area of a triangle based on two sides of the triangle and an angle between the two sides.

The manner of determining the first location information shown in FIG. 4 is only exemplary, and not intended to limit the scope of the present disclosure. For persons having ordinary skills in the art, multiple variations and modifications may be made under the teachings of the present disclosure. However, those variations and modifications do not depart from the scope of the present disclosure. For example, the processor 120 may determine the first location information based on other reflection regions. In some embodiments, the processor 120 may determine the first location information based on three second reflection regions and formulas (1)-(6). In some embodiments, the processor 120 may determine the first location information based on two first reflection regions, a second reflection region between the two first reflection regions, and formulas (1)-(6). In some embodiments, the processor 120 may determine the first location information based on two second reflection regions, a first reflection region between the two second reflection regions, and formulas (1)-(6).

In some embodiments, when the three first reflection regions are unequally spaced, assuming that a distance between the centers of every two adjacent first reflection regions is w1 and w2, respectively, the first location information of the target may also be determined based on w1, w2, α, and β, on the basis of the principle for determining an area of a triangle by multiplying a base by a height of the triable and the principle for determining an area of a triangle based on two sides of the triangle and an angle between the two sides.

In some embodiments, when using more than three reflection regions of the target to determine the first location information of the target, the first location information of the target may also be determined based on the distance between every two adjacent reflection regions of the more than three reflection regions and the angle differences between the laser reflection angles of every two adjacent reflection regions of the more than three reflection regions, on the basis of the principle for determining an area of a triangle by multiplying a base by a height of the triable and the principle for determining an area of a triangle based on two sides of the triangle and an angle between the two sides.

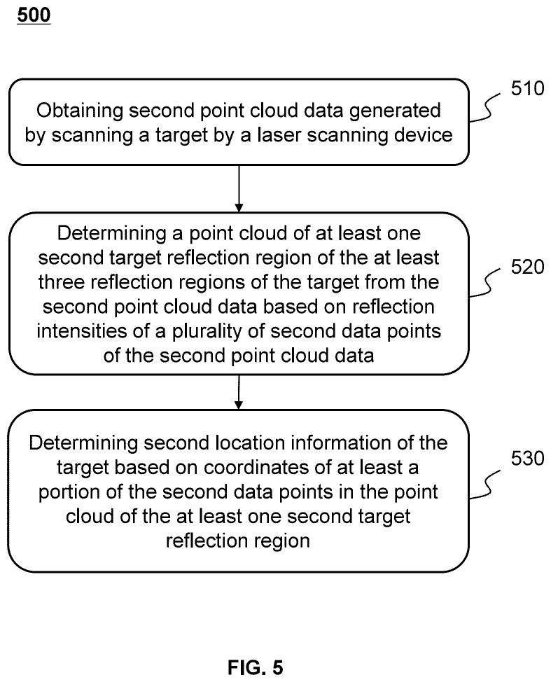

FIG. 5 is a schematic diagram illustrating an exemplary process for locating a target according to some embodiments of the present disclosure. In some embodiments, the process 500 may be implemented in the system 100 illustrated in FIG. 1. For example, the process 500 may be stored in a storage medium (e.g., the storage device 140, a storage 11 illustrated in FIG. 14, etc.) as a form of instructions, and can be invoked and/or executed by a processing device (e.g., the processor 120, a processor 12 illustrated in FIG. 14, or one or more modules illustrated in FIG. 9). The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting. In some embodiments, the process 500 may be performed by the device 111, the processor 120, or the terminal device 130. For the purpose of illustration, in the following descriptions, the process 500 performed by the processor 120 is described as an example.

In 510, the processor 120 may obtain second point cloud data generated by scanning a target by a laser scanning device.

The second point cloud data refers to a dataset obtained by scanning the target by the laser scanning device. In some embodiments, the second point cloud data may include a plurality of second data points.

In some embodiments, the second point cloud data may be obtained by scanning the at least three reflection regions of the target by the laser scanning device. The concept of the second point cloud data may be similar to the concept of the first point cloud data. The concept of the second data point may be similar to the concept of the first data point.

In 520, the processor 120 may determine a point cloud of at least one second target reflection region of the at least three reflection regions of the target from the second point cloud data based on reflection intensities of a plurality of second data points of the second point cloud data.

In some embodiments, the at least one second target reflection region may include at least one first target reflection region. In some embodiments, the at least one second target reflection region may include at least one second target reflection region. In some embodiments, the at least one second target reflection region may include at least one first target reflection region and at least one second target reflection region. The processor 120 may determine the point cloud of the at least one second target reflection region from the second point cloud data based on a manner similar to that of the operation 220. Detailed descriptions may be found in the related descriptions above.

In some embodiments, the processor 120 may select at least one reflection region of the target with a greater width as the at least one second target reflection region. For example, the target may include three first reflection regions with a smaller width and two second reflection regions with a greater width (as shown in FIG. 3). The processor 120 may select the two second reflection regions as the second target reflection regions.

In some embodiments of the present disclosure, when the second point cloud data is obtained, the farther the laser scanning device is away from the target, and the greater the width of the at least one second target reflection region, the higher the accuracy of the second point cloud data obtained by the scanning, and selecting the reflection regions with a greater width improves the accuracy of target localization. Furthermore, the greater the width of the reflection region, the more the data points the reflection region corresponds to, thus reducing the error and improving the accuracy of subsequent target localization.

In 530, the processor 120 may determine second location information of the target based on coordinates of at least a portion of the second data points in the point cloud of the at least one second target reflection region.

The second location information refers to a position and an attitude of the target relative to the autonomous mobile device. The concept of the second location information of the target may be similar to the concept of the first location information of the target illustrated in operation 240.

In some embodiments, the processor 120 may determine, based on the coordinates of at least a portion of the second data points in the point cloud of the at least one second target reflection region, a straight line (or an equation of the straight line); and determine, based on the straight line (or the equation of the straight line), the second location information of the target.

In some embodiments, the processor 120 may extract the coordinates of at least a portion of the second data points in the point cloud of the at least one second target reflection region to perform coordinate fitting, and determine whether it is possible to extract a straight line from the extracted coordinates based on fitting results. An exemplary fitting method may include a Split-Merge algorithm, an Incremental algorithm, Hough Transform, etc.

If the reflection region with a greater width is selected as the at least one second target reflection region, the at least one second target reflection region may correspond to more second data points, thereby leading to a more accuracy result for extracting a straight line.

In some embodiments, in response to determining that it cannot extract a straight line from the extracted coordinates, the processor 120 may determine whether a count of failures of straight line extraction is greater than a threshold. In response to determining that count of failures of straight line extraction is less than or equal to the threshold, the processor 120 may cause the laser scanning device to perform a new scan of the target, and the processor 120 may perform the process 500 again. In response to determining that the count of failures of straight line extraction is greater than the threshold, it may indicate that the autonomous mobile device has a malfunction, and an alarm may be automatically issued to cause the autonomous mobile device to stop moving.

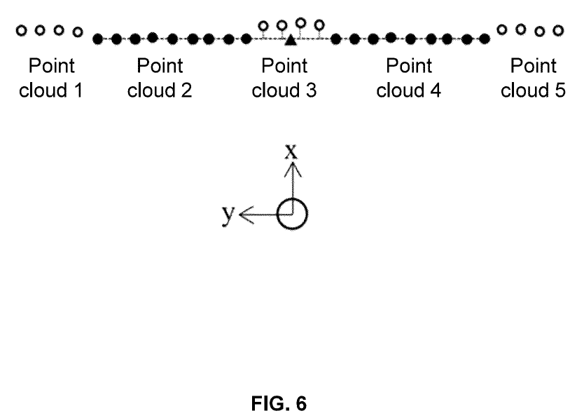

In some embodiments, if a straight line is determined from the extracted coordinates, the second location information of the target may be determined based on the determined straight line. FIG. 6 is a schematic diagram illustrating an exemplary distribution of point clouds according to some embodiments of the present disclosure. As shown in FIG. 6, point cloud 1, point cloud 3, and point cloud 5 may be point clouds corresponding to three first reflection regions, and point cloud 2 and point cloud 4 may be point clouds corresponding to two second reflection regions. After a straight line is extracted, the processor 120 may determine second location information of target based on at least a portion of the point cloud 1, the point cloud 2, the point cloud 3, the point cloud 4, and the point cloud 5, and the determined straight line equation.

In some embodiments, the processor 120 may determine the second location information of the target based on the coordinates of at least a portion of the second data points in the point clouds of the at least three reflection regions of the target. The processor 120 may determine an x-component and a y-component of the target under a preset coordinate system (e.g., a laser coordinate system) based on coordinates of second data points of the reflection region located at the center of the target, and determine a yaw angle of the target under the preset coordinate system based on an x-coefficient and a y-coefficient in the equation of the straight line, thereby obtaining the second location information of the target under the preset coordinate system. The x-component of the target under the preset coordinate system refers to a coordinate of the target of an x axis of the preset coordinate system, and the y-component of the target under the preset coordinate system refers to a coordinate of the target of a y axis of the preset coordinate system.

Merely by way of example, as shown in FIG. 6, the processor 120 may determine the x-component and the y-component of the target based on the coordinates of the second data points of point cloud 3 corresponding to which the reflection region is located at the center of the target.

In some embodiments, the processor 120 may determine a set of projection points by projecting at least a portion of the second data points in the point clouds of the at least three reflection regions of the target onto the straight line; and determine, based on coordinates of the projection points in the set of projection points and the straight line, the second location information.

In some embodiments, assuming that the equation of the determined straight line is ax+by +c=0, wherein [a, b, c] denote parameters of the straight line; and that the second data points in the point cloud of the reflection region corresponding to the middle of the target is {pₘ, . . . , pₙ}, the processor 120 may project {pₘ, . . . , pₙ} onto the straight line to obtain the set of projection points {p′ₘ, . . . , p′ₙ}, wherein coordinates (p′_{i_x}, p′_{i_y}) of a projection point p′ᵢ (i=m, . . . , n) are denoted as:

$${p}_{i \_ x}^{′} = \frac{{b}^{2} {p}_{{i}_{x}} - {abp}_{{i}_{y}} - ac}{{a}^{2} + {b}^{2}} , and {p}_{i \_ y}^{′} = \frac{{a}^{2} {p}_{{i}_{x}} - {abp}_{{i}_{y}} - bc}{{a}^{2} + {b}^{2}} ,$$

wherein pᵢ_{ₓ} and pᵢ_{_{y}} refer to coordinates of a second data point pᵢ (i=m, . . . , n) corresponding to the projection point p′ᵢ.

In some embodiments, the processor 120 may use the mean value of the x-components of all of the projection points as the x-component in the second location information. For example, the processor 120 may use the mean value of the x-components of all of the projection points as the x-component

$${x}_{f}^{L}$$

in the second location information through

$${x}_{f}^{L} = \frac{1}{n - m + 1} {\sum }_{i = m}^{n} {p}_{i \_ x}^{′} .$$

In some embodiments, the processor 120 may use the mean value of the y-components of all of the projection points as the y-component in the second location information. For example, the processor 120 may use the mean value of the y-components of all of the projection points as the y-component

$${y}_{f}^{L}$$

in the second location information through

$${y}_{f}^{L} = \frac{1}{n - m + 1} {\sum }_{i = m}^{n} {p}_{i \_ y}^{′} .$$

In some embodiments, the processor 120 may determine the yaw angle in the second location information based on the x-coefficient and the y-coefficient in the equation of the straight line. For example, the processor 120 may determine the yaw angle

$${θ}_{f}^{L}$$

in the second location information through

$${θ}_{f}^{L} = {tan}^{- 1} \frac{b}{a} .$$

By the above method, the processor 120 may obtain the second location information

$${T}_{f}^{L} = [ {x}_{f}^{L} , {y}_{f}^{L} , {θ}_{f}^{L} ]$$

of the target in the laser coordinate system.

In some embodiments, the processor 120 may also directly use the mean value of the x-components of at least a portion of the second data points of the point clouds of the target as the x-component in the second location information, use the mean value of the y-components of the at least a portion of the second data points of the target as the y-component in the second location information, and determine the yaw angle in the second location information based on the x-coefficient and the y-coefficient in the equation of the straight line, without projecting the second data points onto the straight line.

In some cases, there may be at least two targets in the scanning range of the laser scanning device. The second point cloud data scanned by the laser scanning device may include point cloud data of the at least two targets. In some embodiments, when the second point cloud data scanned by the laser scanning device includes the point cloud data of the at least two targets, at least two straight lines may be extracted.

In some embodiments, in response to determining that at least two straight lines are extracted, the processor 120 may determine an estimated location information corresponding to each of the at least two straight lines; and determine, among the estimated location information corresponding to the at least two straight lines, the estimated location information closest to the laser scanning device in a target direction as the second location information of the target. The target direction may be a direction perpendicular to a movement direction of the laser scanning device. For example, for each of the at least two straight lines determined by the processor 120, the processor 120 may determine the estimated location information corresponding to the straight light; and determine the estimated location information closest to the laser scanning device in left and right directions as the second location information of the target. Assuming that a y-component in the estimation location information represents a distance from the laser scanning device in the left and right directions, after the estimated location information of all the straight lines determined, the estimated location information with a smallest y-component among all the estimated location information may be determined as the second location information of the target.

In some embodiments, the processor 120 may determine a distance between the target and the laser scanning device (or the device 111). As used in the present disclosure, the location of the laser scanning device and the location of the device 111 may be used interchangeably. In some embodiments, the distance between the target and the laser scanning device may be a distance between the current location of the laser scanning device and the location of the target obtained by latest target localization. In some embodiments, the distance between the target and the laser scanning device may also be a distance between the current location of the laser scanning device and an estimated position of the target labeled in a map.

The processor 120 may determine whether the distance between the target and the laser scanning device is greater than or equal to a first distance threshold. In response to determining that the distance between the target and the laser scanning device is greater than or equal to the first distance threshold, the laser scanning device may have a low measurement accuracy of laser reflection angles and a high measurement accuracy of coordinates and distances of the target. The processor 120 may perform the process 500 for locating the target. In response to determining that the distance between the target and the laser scanning device is less than the first distance threshold, the laser scanning device may have a high measurement accuracy of laser reflection angles and a low measurement accuracy of coordinates and distances of the target. The processor 120 may perform the process 200 for locating the target. The first distance threshold may be preset.

In some embodiments, the closer the distance between the laser scanning device and the target, the higher the accuracy of the measurement of the laser reflection angles, and the farther the distance between the laser scanning device and the target, the higher the accuracy of the measurement of the coordinates and the distances of the target.

In some embodiments, the closer the laser scanning device is to the target, the higher the accuracy of the measurement of the laser reflection angle, and the lower the accuracy of the measurement of the distances and the coordinates of the target. It can be seen that in the process 200 for locating the target, the processor 120 may ignore the measurement of the distances and the coordinates of the target, thereby further improving the accuracy of locating the target, and obtaining a better target localization effect when the laser scanning device is close to the target. For example, as shown in formulas (1) and (5), only the laser reflection angles and the distance between every two adjacent reflection regions are used to determine the first location information of the target, without using the measurement of the distances and the coordinates of the target.

In some embodiments of the present disclosure, by utilizing the property that the closer the distance, the higher the measurement accuracy of the laser reflection angle, the close-range positioning accuracy of the target can be improved by target identification based on the laser reflection angles when the distance between the target and the laser scanning device is less than the first distance threshold, so that the method for locating the target of the embodiments of the present disclosure can more accurately identify the location information of the target even when the distance to the target is relatively short.

Some embodiments of the present disclosure further provide a method for device docking.

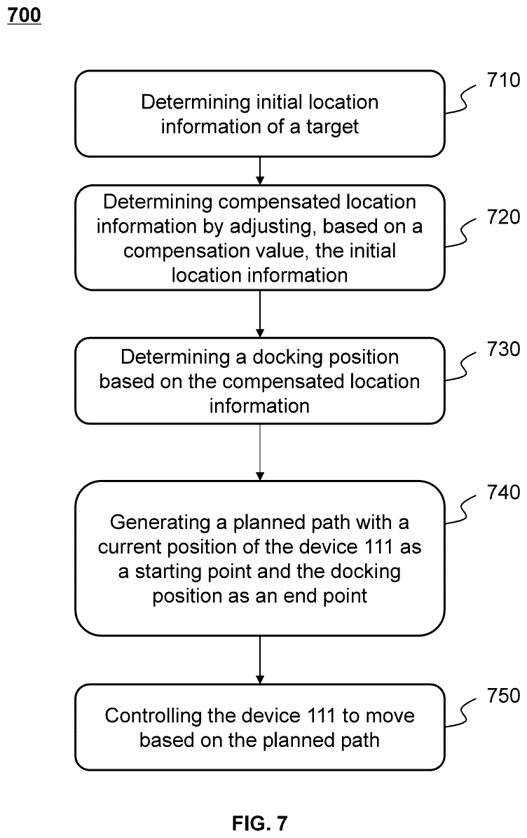

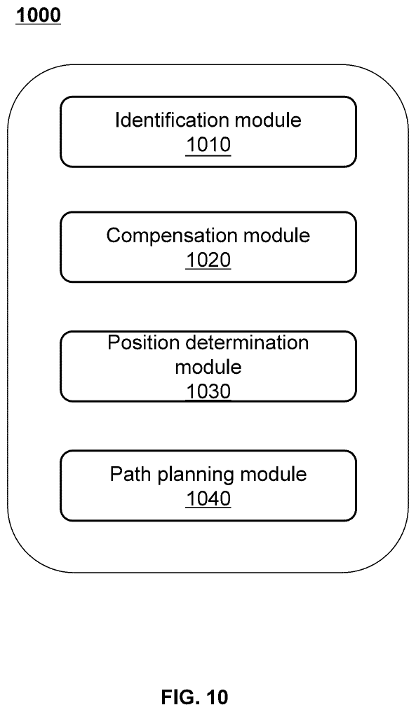

FIG. 7 is a flowchart illustrating an exemplary process for device docking according to some embodiments of the present disclosure. In some embodiments, the process 700 may be implemented in the system 100 illustrated in FIG. 1. For example, the process 700 may be stored in a storage medium (e.g., the storage device 140, a storage 11 illustrated in FIG. 14, etc.) as a form of instructions, and can be invoked and/or executed by a processing device (e.g., the processor 120, a processor 12 illustrated in FIG. 14, or one or more modules illustrated in FIG. 10). The operations of the illustrated process 700 presented below are intended to be illustrative. In some embodiments, the process 700 may be accomplished with one or more additional operations not described, and/or without one or more of the operations discussed. Additionally, the order in which the operations of the process 700 as illustrated in FIG. 7 and described below is not intended to be limiting. In some embodiments, the process 700 may be performed by the device 111, the processor 120, or the terminal device 130. For the purpose of illustration, in the following descriptions, the process 700 performed by the processor 120 is described as an example.

In some embodiments, the processor 120 may control a device (e.g., the device 111) to move to a target position and complete docking of the device with a docking target based on the process 700. The target position refers to a position where the device 111 and the docking target are actually docked.

In 710, the processor 120 may determine initial location information of a target.

In some embodiments, the processor 120 may perform the process 200 to determine the first location information of the target, and determine the first location information of the target as the initial location information of the target. In some embodiments, the processor 120 may perform the process 500 to determine the second location information of the target, and determine the second location information of the target as the initial location information of the target. In some embodiments, the processor 120 may determine a distance between the target and the laser scanning device. The processor 120 may determine whether the distance between the target and the laser scanning device is greater than or equal to a first distance threshold. In response to determining that the distance between the target and the laser scanning device is less than the first distance threshold, the processor 120 may perform the process 200 for locating the target, and determine the first location information of the target as the initial location information of the target. In response to determining that the distance between the target and the laser scanning device is greater than or equal to the first distance threshold, the processor 120 may perform the process 500 for locating the target, and determine the second location information of the target as the initial location information of the target.

In 720, the processor 120 may determine compensated location information by adjusting the initial location information based on a compensation value.

The compensation value refers to a value for correcting or adjusting the initial location information of the target. In some embodiments, the compensation value may include a value for correcting or adjusting at least one of coordinates and a yaw angle in the initial location information of the target.

In some embodiments, the compensation value may be a preset compensation value when docking of the device 111 with the docking target is first performed. For example, the preset compensation value may be 0, indicating that when docking of the device 111 with the docking target is first performed, the initial location information of the target is not required to be adjusted.

In some embodiments, the preset compensation value when docking of the device 111 with the docking target is first performed may also be determined based on a compensation value determination model that is a machine learning model.

In some embodiments, an input of the compensation value determination model may include a configuration parameter (e.g., a laser emission intensity, a laser receiving sensitivity, etc.) of the laser scanning device, a feature (e.g., a reflective property of each of the at least three reflection regions, a size of each of the at least three reflection regions, a count of the at least three reflection regions, etc.) associated with the at least three reflection regions of the target, etc., and an output of the compensation value determination model may include the preset compensation value.

In some embodiments, the compensation value determination model may be trained based on a plurality of training samples. A training sample may correspond to a sample docking of a sample laser scanning device with a sample docking target by scanning a sample target. The training sample may include an emission intensity and a receiving sensitivity of the sample laser scanning device, the reflective property of each of the reflection regions of the sample target, the size of each of the reflection regions of the sample target, the count of the reflection regions of the sample target. A training label corresponding to the training sample may include a deviation value between a planned docking position and an actual docking position in the sample docking.

In some embodiments of the present disclosure, the preset compensation value may be determined through the machine learning model, which reduces the deviation of the first docking, and improves the accuracy of the first docking.

In 730, the processor 120 may determine a docking position based on the compensated location information.

The docking position refers to a position where the device 111 eventually stop to dock with the docking target. In some embodiments, the docking position may be determined based on the compensated location information of target. For example, a location difference between the actual location of the target and the actual location of the docking target may be obtained in advance. The processor 120 may determine the docking position based on the compensated location information of target and the location difference. In some embodiments, the processor 120 may determine the compensated location information of the target as the docking position.

In 740, the processor 120 may generate a planned path with a current position of the device 111 as a starting point and the docking position as an end point, and control the device 111 to move based on the planned path.

In some embodiments, in order to facilitate path planning, when the docking position and the current position of the device are in different coordinate systems, the processor 120 may adjust the docking position and/or the current position of the device to make the adjusted docking position and/or the adjusted current position of the device into the same coordinate system. For example, the processor 120 may convert the docking position (or the initial position information, or the compensated location information) into the coordinate system of the current position of the device. As another example, the processor 120 may convert the current position of the device into the coordinate system of the docking position (or the initial position information, or the compensated location information). As still another example, the processor 120 may convert the current position of the device and the docking position (or the initial position information, or the compensated location information) into a third coordinate system.

In some embodiments, the processor 120 may project the initial position information onto the coordinate system in which the current position of the device is located. For example, assuming that the initial position information may be location information

$${T}_{f \_ far}^{L} = [ {x}_{f \_ far}^{L} , {y}_{f \_ far}^{L} , {θ}_{f \_ far}^{L} ]$$

in the laser coordinate system, the device has a current location

$${T}_{B}^{M}$$

in a map coordinate system, and the laser scanning device has a mounting external parameter

$${T}_{L}^{B} ,$$

the initial position information may be projected to the map coordinate system as

$${T}_{f \_ far}^{M} = {T}_{B}^{M} \cdot {T}_{L}^{B} \cdot {T}_{f \_ far}^{L} .$$

As another embodiment, the initial location information may be location information

$${T}_{f\_far}^{L} = [ {x}_{f\_far}^{L} , {y}_{f\_far}^{L} , {θ}_{f\_far}^{L} ]$$

in the laser coordinate system. The compensated location information may be

$${{T}_{f\_far}^{L}}^{′} = ϵ \cdot {T}_{f\_far}^{L}$$

in the laser coordinate system, wherein e refers to the compensation value. The compensated location information may be projected to the map coordinate system as

$${{T}_{f\_far}^{M}}^{′} = {T}_{B}^{M} \cdot {T}_{L}^{B} \cdot ϵ \cdot {T}_{f\_far}^{L}$$

based on the current location

$${T}_{B}^{M}$$

of the device in the map coordinate system and the mounting external parameter

$${T}_{L}^{B}$$

of the laser Scanning device.

In some embodiments, coordinate system conversion may not be performed for the docking position (or the initial position information, or the compensated location information).

In some embodiments, path planning may be determined based on various ways, such as a graph search algorithm, a dynamic planning method, etc.

In some embodiments, the processor 120 may send the planned path to the device to cause the device to move based on the planned path.

In some embodiments, the processor 120 may determine an identification starting point and an identification end point. In response to determining that the device is located between the identification starting point and the identification end point, the processor 120 may perform the method of the process 700 at a preset frequency; and in response to determining that the device is located between the identification end point and the target, the processor 120 may determine a docking position corresponding to a last planned path as the target position, and control the device to move to the target position based on the last planned path.

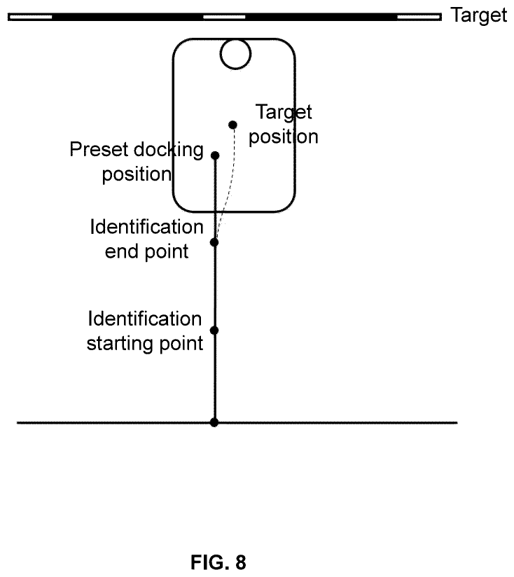

FIG. 8 is a schematic diagram illustrating exemplary positions of an identification starting point and an identification end point according to some embodiments of the present disclosure.

The identification starting point refers to a position where a processor 120 starts identifying a target. The identification end point refers to a position where the processor 120 stops identifying the target.

In some embodiments, the identification end point may be closer to the target than the identification starting point, as shown in FIG. 8.

When the device is located between the identification starting point and the identification end point, the processor 120 may perform the process 700 at a preset frequency, so that the location information of the target may be more accurately identified through an identification range with a relatively high identification accuracy between the identification starting point and the identification end point, thereby improving the accuracy of the planned path generated based on the location information of the target, so that the device may arrive at the docking target more accurately. The identification starting point and the identification end point may be related to the docking target. Specifically, the identification starting point and the identification end point may be determined based on the location information of the docking target, and further, the identification starting point and the identification end point may be determined based on a distance from the docking target. In the beginning of the device moving to the docking target, the device may move based on a preset docking path, and the processor 120 may determine the identification starting point and the identification end point based on the preset docking path. The preset docking path may be determined based on a preset position of the target or the docking target.

In some embodiments, in the preset docking path, the processor 120 may determine a location of a first distance from the preset docking position as the identification starting point, and determine a location of a second distance from the preset docking position as the identification end point. The first distance may be shorter than the second distance.

In some embodiments, a long-range identification of the target (e.g., the process 500 in FIG. 5) may be performed to determine the initial location information of the target when the laser scanning device is located between the identification starting point and the identification end point. In some embodiments, a close-range identification of the target (e.g., the process 200 in FIG. 2) may be performed to determine the initial location information of the target when the laser scanning device is located between the identification starting point and the identification end point.

In some embodiments, a distance between the identification starting point and the target, and a distance between the identification end point and the target may be both greater than or equal to the distance threshold. In this case, the long-range identification of the target (e.g., the process 500 in FIG. 5) may be performed to determine the initial location information of the target when the laser scanning device is located between the identification starting point and the identification end point. In some embodiments, a distance between the identification starting point and the target, and a distance between the identification end point and the target may be both less than the distance threshold. In this case, the close-range identification of the target (e.g., the process 200 in FIG. 2) may be performed to determine the initial location information of the target when the laser scanning device is located between the identification starting point and the identification end point. In some embodiments, a distance between the identification starting point and the target may be greater than the distance threshold, and a distance between the identification end point and the target may be less than the distance threshold. When the laser scanning device is located between the identification starting point and the identification end point, in response to determining that a distance between the laser scanning device and the target is greater than or equal to the distance threshold, the long-range identification of the target may be performed to determine the initial location information of the target; or in response to determining that a distance between the laser scanning device and the target is less than the distance threshold, the close-range identification of the target may be performed to determine the initial location information of the target.

In some embodiments of the present disclosure, because the identification accuracy of the target is insufficient when the device does not reach the identification starting point, the processor 120 may not identify the target when the device does not reach the identification starting point. When the device exceeds the identification end point, the updated path cannot be executed due to the close distance between the device and the docking target. Therefore, the processor 120 may not identify the target and may not update the path when the device exceeds the identification end point. The above operations can reduce unnecessary target identification and path planning, save computing resources, and improve the accuracy of target docking.

In some embodiments, after the device passes through the identification starting point, the location information of the target may be identified and updated multiple times, and a movement path of the device may change accordingly. Correspondingly, the identification end point may be updated accordingly. The processor may update the identification end point based on an updated movement path. When the processor 120 generates a planned path with a current position of the device as a starting point and the docking position as an end point, the processor 120 may update the identification end point in the planned path. For example, in the planned path, the processor 120 may determine a location of the second distance from the docking position as the updated identification end point.

In some embodiments, in response to determining that the device is located between the identification end point and the target, and the distance between the device and the target is too close for the generated path to be executed, the processor 120 may use the docking position corresponding to the last planned path as the target position, and control the device to move to the target position based on the last planned path.

In some embodiments, after the device reaches the target position, the processor 120 may cause the laser scanning device of the device to scan the target at the target position, and determine test location information of the target based on the process 200.

In some embodiments, the processor 120 may determine, based on the test location information, a deviation value of the device for current docking.

In some embodiments, a location difference between the actual location of the target and the actual location of the docking target may be obtained in advance. The processor 120 may determine the deviation value of the device for current docking based on the location difference and the test location information of the target. For example, the processor 120 may determine a difference or a ratio between the location difference and the test location information of the target as the deviation value of the device for current docking. The test location information of the target may location information of the target in the laser coordinate system determined when the laser scanning device is at the target position, indicating relative location information between the target and the target position of the docking target. The location difference indicates relative location information between the actual location of the target and the actual location of the docking target. Therefore, a difference or a ratio between the test location information of the target and the location difference may approximatively indicate a deviation value of the target identification in the current docking.

In some embodiments, in order to minimize the effect of the way the laser scanning device is set up on the determination of the deviation value, the test location information

$${T}_{f \_ close}^{L}$$

of the target may be converted to the coordinate system of the device. Merely by way of example, the test location information

$${T}_{f\_close}^{L}$$

of the target may be converted to the coordinate system of the device by

$${T}_{f\_close}^{B} = {T}_{L}^{B} \cdot {T}_{f\_close}^{L}$$

to obtain the location information

$${T}_{f\_close}^{B}$$

of the target in the coordinate system of the device; and determine the deviation value h of the device for current docking based on

$$h = {T}_{f\_gt}^{B} \cdot {( {T}_{f\_close}^{B} )}^{- 1} , wherein {T}_{f\_gt}^{B}$$

refers to the location difference between the actual location of the target and the actual location of the docking target.

In some embodiments, the processor 120 may update the compensation value based on the deviation value.

In some embodiments, the processor 120 may update the compensation value to the deviation value. For example, the processor 120 may use the deviation value as an updated compensation value and update the initial location information of the target based on the deviation value (the updated compensation value) for next target docking.

In some embodiments, the processor 120 may determine a mean value or a median value of the deviation values of the current docking and at least one previous docking of the device; and update the compensation value to the mean value or the median value. For example, the processor 120 may record the deviation value of each docking, and determine the mean value or the median value of the deviation values of the current docking and the at least one previous docking of the device, use the mean value or the median value as the updated compensation value, and update the initial location information of the target for next target docking based on the updated compensation value.

In some embodiments of the present disclosure, the deviation value when the device is docked with the target is determined, and the compensation value is updated based on the deviation value, which improves the accuracy of the compensation value, and obtains a better target docking effect. Furthermore, the compensation value may be updated based on the deviation values (i.e., deviations of the historical docking processes) of the current docking and the at least one previous docking of the device, which further improves the accuracy of the compensation value, and further improves the target docking effect.

In some embodiments, the processor 120 may obtain a preset position of the target or the docking target, and determine a preset docking path with the current location of the device 111 as the starting point and the preset position as the end point. The processor 120 may determine an identification starting point and an identification end point in the preset docking path. The processor 120 may control the device 111 to move based on the preset docking path. After the device 111 moves to the identification starting point, the processor 120 may cause a laser scanning device of the device 111 to scan a target, and perform identification of the target to determine initial location information of the target. The processor 120 may determine compensated location information of the target by adjusting, based on a compensation value, the initial location information of the target. The processor 120 may determine a docking position based on the compensated location information of the target. The processor 120 may determine a planned (updated) path with the current location of the device 111 as the starting point and the docking position as the end point. The processor 120 may cause the device 111 to move based on the planned path. The processor 120 may update the identification end point in the planned path. The processor 120 may determine whether the device 111 passes through the (updated) identification end point. In response to determining that the device 111 has not passed through the (updated) identification end point, the processor 120 may perform identification of the target to determine initial location information of the target again, and perform path planning (update) again, until the device 111 passes through the identification end point. In response to determining that the device 111 passes through the (updated) identification end point, the processor 120 may stop performing the identification of the target, determine the docking position in the last planned path as a target position, and cause the device 111 to move to the target position based on the last planned path. After the device 111 reaches the target position, the processor 120 may cause the laser scanning device of the device 111 to scan the target at the target position, and perform identification of the target to determine test location information of the target. The processor 120 may update the compensation value based on the test location information. The updated compensation value may be used in a next docking of the device 111 with the docking target. Details regarding the terms and the processes in this embodiment may be found elsewhere in the present disclosure (e.g., similar terms and processes in the description in connection with FIGS. 1-8).

It should be noted that the foregoing descriptions of the processes 200, 500, and 700 are for the purpose of exemplification and illustration only, and do not limit the scope of application of the present disclosure. For a person skilled in the art, various corrections and changes can be made to the processes 200, 500, 700 under the guidance of the present disclosure. However, these corrections and changes remain within the scope of the present disclosure.

FIG. 9 is a block diagram illustrating an exemplary system for locating a target according to some embodiments of the present disclosure. The system 900 may be implemented on the processor 120, the terminal device 130, the electronic device 10, or the device 111 through hardware and/or software.

As shown in FIG. 9, the system 900 for locating a target may include a first acquisition module 910, a selection module 920, a first determination module 930, and a second determination module 940.

The first acquisition module 910 may be configured to obtain first point cloud data generated by scanning a target by a laser scanning device. The first point cloud data may include a plurality of first data points. Details regarding obtaining the first point cloud data generated by scanning the target by the laser scanning device may be found elsewhere in the present disclosure (e.g., the description in connection with operation 210 of the process 200 in FIG. 2).

The selection module 920 may be configured to determine, based on reflection intensities of the plurality of first data points, point clouds of at least three first target reflection regions of the at least three reflection regions from the first point cloud data. Details regarding determining, based on reflection intensities of the plurality of first data points, point clouds of at least three first target reflection regions of the at least three reflection regions from the first point cloud data may be found elsewhere in the present disclosure (e.g., the description in connection with operation 220 of the process 200 in FIG. 2).

In some embodiments, the point clouds of the at least three first target reflection regions of the at least three reflection regions determined from the first point cloud data may include point cloud corresponding to at least three first reflection regions.

In some embodiments, the selection module 920 may be further configured to obtain an intensity threshold; determine, based on the intensity threshold and the reflection intensities of the plurality of first data points, at least one first candidate point set and/or at least one second candidate point set from the first point cloud data, the at least one first candidate point set being related to at least two first reflection regions, and the at least one second candidate point set being related to at least one second reflection region; and determine, based on the at least one first candidate point set and/or the at least one second candidate point set, the point clouds of the at least three first target reflection regions.

In some embodiments, in response to determining that a count of the at least one first candidate point set is not equal to a count of the at least two first reflection regions, and/or a count of the at least one second candidate point set is not equal to a count of the at least one second reflection region, the selection module 920 may be further configured to determine, based on a preset distance range and/or a preset angle range, the point clouds of the at least three first target reflection regions from the at least one first candidate point set and/or the at least one second candidate point set.

The first determination module 930 may be configured to determine, based on the point clouds of the at least three first target reflection regions, a laser reflection angle of each of the at least three first target reflection regions. Details regarding determining, based on the point clouds of the at least three first target reflection regions, a laser reflection angle of each of the at least three first target reflection regions may be found elsewhere in the present disclosure (e.g., the description in connection with operation 230 of the process 200 in FIG. 2).

The second determination module 940 may be configured to determine, based on the laser reflection angle of each of the at least three first target reflection regions, first location information of the target. Details regarding determining, based on the laser reflection angle of each of the at least three first target reflection regions, first location information of the target may be found elsewhere in the present disclosure (e.g., the description in connection with operation 240 of the process 200 in FIG. 2).

In some embodiments, the second determination module 940 may be further configured to determine, based on the laser reflection angle of each of the at least three first target reflection regions, an angle difference between the laser reflection angles of every two adjacent first target reflection regions; and determine, based on the angle difference and a distance between every two adjacent first target reflection regions, the first location information of the target.

In some embodiments, the first acquisition module 910 may be configured to obtain second point cloud data generated by scanning a target by a laser scanning device. Details regarding obtaining second point cloud data generated by scanning a target by a laser scanning device may be found elsewhere in the present disclosure (e.g., the description in connection with operation 510 of the process 500 in FIG. 5).

The selection module 920 may be configured to determine a point cloud of at least one second target reflection region of the at least three reflection regions of the target from the second point cloud data based on reflection intensities of a plurality of second data points of the second point cloud data. Details regarding determining a point cloud of at least one second target reflection region of the at least three reflection regions of the target from the second point cloud data based on reflection intensities of a plurality of second data points of the second point cloud data may be found elsewhere in the present disclosure (e.g., the description in connection with operation 520 of the process 500 in FIG. 5).

The second determination module 940 may be configured to determine second location information of the target based on coordinates of at least a portion of the second data points in the point cloud of the at least one second target reflection region. Details regarding determining second location information of the target based on coordinates of at least a portion of the second data points in the point cloud of the at least one second target reflection region may be found elsewhere in the present disclosure (e.g., the description in connection with operation 530 of the process 500 in FIG. 5).

It is to be noted that the above description of the system 900 for locating the target and modules thereof is provided only for descriptive convenience, and does not limit the present disclosure to the scope of the cited embodiments. It is to be understood that for a person skilled in the art, after understanding the principle of the system, it may be possible to arbitrarily combine the individual modules or form a sub-system to be connected to the other modules without departing from the principle. In some embodiments, the modules described above may be different modules in a single system, or a single module may implement the functions of two or more of the modules described above. For example, the individual modules may share a common storage module, and the individual modules may each have their own storage module. Such variations are within the scope of protection of the present disclosure.

FIG. 10 is a block diagram illustrating an exemplary system for device docking according to some embodiments of the present disclosure. The system 1000 may be implemented on the processor 120, the terminal device 130, the electronic device 10, or the device 111 through hardware and/or software.

As shown in FIG. 10, the system 1000 for device docking may include an identification module 1010, a compensation module 1020, a position determination module 1030, and a path planning module 1040.

The identification module 1010 may be configured to determine initial location information of a target. Details regarding determining initial location information of a target may be found elsewhere in the present disclosure (e.g., the description in connection with operation 710 of the process 700 in FIG. 7).

The compensation module 1020 may be configured to determine compensated location information by adjusting the initial location information based on a compensation value. Details regarding determining compensated location information by adjusting the initial location information based on a compensation value may be found elsewhere in the present disclosure (e.g., the description in connection with operation 720 of the process 700 in FIG. 7).

In some embodiments, after a device moves to a target position, the compensation module 1020 may be further configured to obtain first point cloud data generated by scanning the target by a laser scanning device of the device, the first point cloud data including a plurality of first data points; determine, based on reflection intensities of the plurality of first data points, point clouds of at least three first target reflection regions of the at least three reflection regions from the first point cloud data; determine, based on the point clouds of the at least three first target reflection regions, a laser reflection angle of each of the at least three first target reflection regions; and determine, based on the laser reflection angle of each of the at least three first target reflection regions, first location information of the target.

In some embodiments, the compensation module 1020 may be further configured to update the compensation value to a deviation value.

In some embodiments, the compensation module 1020 may be further configured to determine a mean value or a median value of the deviation values of current docking and at least one previous docking of the device; and update the compensation value to the mean value or the median value.

The position determination module 1030 may be configured to determine a docking position based on the compensated location information. Details regarding determining a docking position based on the compensated location information may be found elsewhere in the present disclosure (e.g., the description in connection with operation 730 of the process 700 in FIG. 7).

The path planning module 1040 may be configured to generate a planned path with a current position of the device as a starting point and the docking position as an end point, and control the device to move based on the planned path. Details regarding generating a planned path with a current position of the device as a starting point and the docking position as an end point, and controlling the device to move based on the planned path may be found elsewhere in the present disclosure (e.g., the description in connection with operations 740 and 750 of the process 700 in FIG. 7).

In some embodiments, the path planning module 1040 may be further configured to determine an identification starting point and an identification end point; in response to determining that the device is located between the identification starting point and the identification end point, perform the method of the process 700 at a preset frequency; or in response to determining that the device is located between the identification end point and the target, determine the docking position corresponding to a last planned path as the target position, and control the device to move to the target position based on the last planned path.

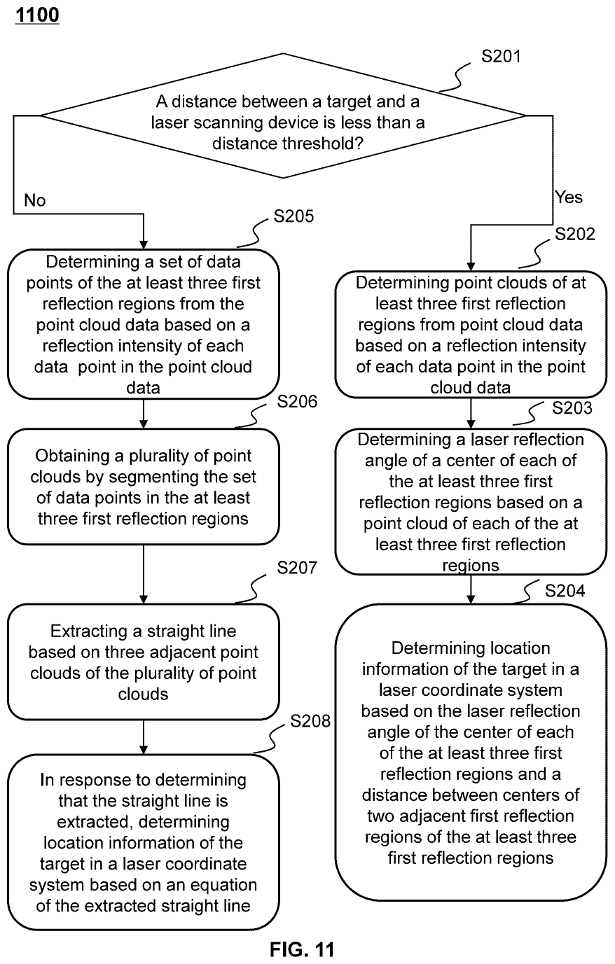

FIG. 11 is a flowchart illustrating an exemplary process for locating a target according to some embodiments of the present disclosure. In some embodiments, the process 1100 may be implemented in the system 100 illustrated in FIG. 1. For example, the process 1100 may be stored in a storage medium (e.g., the storage device 140, a storage 11 illustrated in FIG. 14, etc.) as a form of instructions, and can be invoked and/or executed by a processing device (e.g., the processor 120, a processor 12 illustrated in FIG. 14, or one or more modules illustrated in FIG. 9). The operations of the illustrated process 1100 presented below are intended to be illustrative. In some embodiments, the process 1100 may be accomplished with one or more additional operations not described, and/or without one or more of the operations discussed. Additionally, the order in which the operations of the process 1100 as illustrated in FIG. 11 and described below is not intended to be limiting. In some embodiments, the process 1100 may be performed by the device 111, the processor 120, or the terminal device 130. For the purpose of illustration, in the following descriptions, the process 1100 performed by the processor 120 is described as an example.

In S201, the processor 120 may determine whether a distance between a target and a laser scanning device is less than a distance threshold.

Whether the distance between the target and the laser scanning device is less than the distance threshold may be determined first; if the distance between the target and the laser scanning device is less than the distance threshold, S202 may be performed, the identification accuracy of the target at a close distance may be improved by performing target identification based on laser reflection angle; if the distance between the target and the laser scanning device is greater than the distance threshold, S205 may be performed, and the location information of the target may be determined based on coordinates of point clouds, so that the location information of the target may be accurately determined using the coordinates of point clouds based on the characteristic of high measurement accuracy of point clouds when the distance between the laser scanning device and the target is large.

In some embodiments, the distance between the target and the laser scanning device may be estimated, and whether an estimated distance is less than the distance threshold may be determined. If the estimated distance is less than the distance threshold, the distance between the target and the laser scanning device may be determined to be less than the distance threshold; and if the estimated distance is greater than the distance threshold, the distance between the target and the laser scanning device may be determined to be greater than the distance threshold.

In some embodiments, an identification starting point and an identification end point may be preset based on a position of the target.

In some embodiments, a distance between the identification starting point and the target, and a distance between the identification end point and the target may be both greater than or equal to the distance threshold. A long-range identification of the target (e.g., the process 500 in FIG. 5) may be performed when the laser scanning device is located between the identification starting point and the identification end point. In some embodiments, a distance between the identification starting point and the target, and a distance between the identification end point and the target may be both less than the distance threshold. A close-range identification of the target (e.g., the process 200 in FIG. 2) may be performed when the laser scanning device is located between the identification starting point and the identification end point. In some embodiments, a distance between the identification starting point and the target may be greater than the distance threshold, and a distance between the identification end point and the target may be less than the distance threshold. When the laser scanning device is located between the identification starting point and the identification end point, in response to determining that a distance between the laser scanning device and the target is greater than or equal to the distance threshold, the long-range identification of the target may be performed; or in response to determining that a distance between the laser scanning device and the target is less than the distance threshold, the close-range identification of the target may be performed.

In S202, the processor 120 may determine point clouds of at least three first reflection regions from the point cloud data based on a reflection intensity of each data point in the point cloud data.

In S203, the processor 120 may determine a laser reflection angle of a center of each of the at least three first reflection regions based on a point cloud of each of the at least three first reflection regions.

In S204, the processor 120 may determine location information of the target in a laser coordinate system based on the laser reflection angle of the center of each of the at least three first reflection regions and a distance between centers of two adjacent first reflection regions of the at least three first reflection regions.

In S205, the processor 120 may determine a set of points of the at least three first reflection regions the point cloud data based on a reflection intensity of each data point in the point cloud data.

As the point cloud data is obtained by scanning at least two first reflection regions and at least one second reflection region on the target by the laser scanning device, the obtained point cloud data may include both point cloud data of the at least two first reflection regions, and point cloud data of the at least one second reflection region. Reflective properties of the at least two first reflection regions may be different from a reflective property of the at least one second reflection region, so that whether each of data points in the point cloud data is a data point of the at least two first reflection regions, or a data point of the at least one second reflection region, may be determined by the reflective intensity of each of the data points in the point cloud data. Accordingly, a set of data points of the at least two first reflection regions may be determined from the point cloud data based on the reflective intensity of each of the data points in the point cloud data, thereby facilitating subsequent determination of the location information of the target based on the set of data points in the at least two first reflection regions.

In S206, the processor 120 may obtain a plurality of point clouds by segmenting the set of data points in the at least three first reflection regions.

After the set of the data points in the at least two first reflection regions is determined from the point cloud data, the plurality of point clouds may be obtained by segmenting the set of points in the at least two first reflection regions.

A specific operation manner for segmenting the set of data points in the at least two first reflection regions may be found in the manner of segmenting the point clouds of FIG. 2, which is not repeated here.

In S207, the processor 120 may extract a straight line based on three adjacent point clouds of the plurality of point clouds.

Optionally, after the plurality of point clouds are obtained by segmenting the set of data points in the at least two first reflection regions, the straight line may be extracted based on the three adjacent point clouds of the plurality of point clouds, so that the location information of the target in the laser coordinate system may be determined based on an equation of the extracted straight line in response to determining that the straight line is extracted.

In S208, in response to determining that the straight line is extracted, the processor 120 may determine location information of the target in a laser coordinate system based on an equation of the extracted straight line.

Optionally, the location information of the target in the laser coordinate system may be determined based on the three adjacent point clouds of the plurality of point clouds and at least a portion of points in two point clouds separating the three adjacent point clouds of the plurality of point clouds, and the equation of the extracted straight line. For example, the three adjacent point clouds may be the point cloud 1, the point cloud 3, and the point cloud 5 in FIG. 5, and the two point clouds separating the three adjacent point clouds may be the point cloud 2 and the point cloud 4 in FIG. 5. After the straight line is extracted, the location information of the target in the laser coordinate system may be determined based on the point clouds 1, 2, 3, 4, and 5 and at least a portion of points in the five point clouds, and the equation of the extracted straight line.

More preferably, three first reflection regions may be provided on the target, and the three first reflection regions and one of two second reflection regions on the target may be set at a center of the target, so that in S208, the x-component and the y-component of the target in the laser coordinate system may be determined based on coordinates of points of the reflection regions located at the center of the target on the extracted straight line, and a yaw angle of the target in the laser coordinate system may be determined based on an x-coefficient and a y-coefficient in the equation of the straight line, thereby obtaining the location information of the target in the laser coordinate system. Merely by way of example, the at least two first reflection regions in the middle of the target may be located at the center of the target, centers of the at least two first reflection regions in the middle may be aligned with the center of the target. In S208, the x-component and the y-component of the target in the laser coordinate system may be determined by obtaining a mean value of coordinates of all the points in the point clouds of the at least two first reflection regions in the middle on the extracted straight line.

In addition, considering that at least two targets may be provided in the application scenario of the method for locating the target, the point cloud data scanned by the laser scanning device may include point cloud data of the at least two targets. In this case, in S207, the straight line may be extracted based on every three adjacent point clouds of the plurality of point clouds. If at least two straight lines are extracted based on the plurality of point clouds using S207, for each of at least two straight lines extracted, estimated location information of the target may be determined based on the equation of the extracted straight line; and then the processor 120 may determine the estimated location information corresponding to the straight light; and then the estimated location information of the at least two estimated location information corresponding to the at least two straight lines that is closest to the laser scanning device in left and right directions may be determined as the estimated location information of the target in the laser coordinate system. Assuming that a y-component in the location information of the target in the laser coordinate system represents a distance of the target from the laser scanning device in the left and right directions, after the estimated location information of all the straight lines determined based on the plurality of point clouds is determined, estimated location information with a smallest y-component among all the estimated location information may be determined as the location information of the target in the laser coordinate system.

In some embodiment, the at least two first reflection regions may be high reflection regions, and the at least one second reflection region may be a low reflection region; so that in S205, a set of points in the determined point cloud data of which reflection intensities are greater than an intensity threshold may be determined as a set of points in the at least two first reflection regions; in S207, the operation of “extracting a straight line based on three adjacent point clouds” may include: extracting the straight line based on point clouds between the three adjacent point clouds of which reflection intensities are less than the intensity threshold to obtain the equation of the straight line. In S208, the location information of the target in the laser coordinate system may be determined based on the three adjacent point clouds and at least a portion of points in two point clouds separating the three adjacent point clouds, and the equation of the extracted straight line. If the location information of the target in the laser coordinate system is determined based on at least a portion of points in the three adjacent point clouds and the equation of the extracted straight line, the at least a portion of points in the three adjacent point clouds may be projected onto the equation of the straight line to obtain a set of projection points. Then the estimation location information of the target may be determined based on coordinates of at least a portion of points in the set of projection points and the equation of the straight line. Further, assuming that the equation of the extraction straight line is ax+by +c=0, wherein [a, b, c] denote parameters of the straight line; and that one of the three adjacent point clouds is located at the center of the target, a set of point clouds located at the center of the target are denoted as {pₘ, . . . , pₙ}, and the point clouds located at the center of the target may be projected to the straight line to obtain the set of projection points {p′ₘ, . . . , p′ₙ}, wherein coordinates of an ith point are denoted as:

$${p}_{i\_x}^{′} = \frac{{b}^{2} {p}_{{i}_{x}} - {abp}_{{i}_{y}} - a c}{{a}^{2} + {b}^{2}} ; \qquad {p}_{i\_y}^{′} = \frac{{a}^{2} {p}_{{i}_{x}} - {abp}_{{i}_{y}} - bc}{{a}^{2} + {b}^{2}} ,$$

wherein pᵢ_{ₓ} and pᵢ_{_{y}} refer to coordinates of a second data point pᵢ (i=m, . . . , n) corresponding to the projection point p′ᵢ. The mean value of the x-components of all the points in the set of projection points may be determined as the x-component in the estimated location information through a formula

$${x}_{f}^{L} = \frac{1}{n - m + 1} {\sum }_{i = m}^{n} {p}_{i\_x}^{′} ,$$

the mean value of the y-components of all the points in the set of projection points may be determined as the y-component in the estimated location information through a formula

$${y}_{f}^{L} = \frac{1}{n - m + 1} {\sum }_{i = m}^{n} {p}_{i\_y}^{′} ,$$

and the yaw angle in the estimated location information may be determined based on the x-coefficient and the y-coefficient in the equation of the straight light, so that the location information

$${T}_{f}^{L} = [ {x}_{f}^{L} , {y}_{f}^{L} , {θ}_{f}^{L} ]$$

of the target in the laser coordinate system may be obtained.

In some embodiment, the at least two first reflection regions may be low reflection regions, and the at least one second reflection region may be a high reflection region; so that in S205, a set of points in the determined point cloud data of which the reflection intensities are less than the intensity threshold may be determined as a set of points in the at least two first reflection regions; in S207, the operation of “extracting a straight line based on three adjacent point clouds” may include: extracting the straight line based on the three adjacent point clouds obtain the equation of the straight line; in S208, the location information of the target in the laser coordinate system may be determined based on the three adjacent point clouds and at least a portion of points in two point clouds separating the three adjacent point clouds, and the equation of the extracted straight line.

If the location information of the target in the laser coordinate system is determined based on at least a portion of points in the three adjacent point clouds and the equation of the extracted straight line, coordinates of the at least a portion of points in the three adjacent point clouds may be directly determined to obtain the x-component and the y-component in the estimated location information of the target. In some embodiments, if the location information of the target in the laser coordinate system is determined based on the at least a portion of points in the two point clouds for separating the three adjacent point clouds and the equation of the extracted straight line, the at least a portion of points in the two point clouds may be projected onto the equation of the straight line to obtain the set of projection points; and then the estimated location information of the target may be determined based on the coordinates of the at least a portion of points in the set of projection points and the equation of the straight line.

In addition, in some embodiments, when the distance between the target and the laser scanning device is greater than a distance threshold, a set of points of which reflection intensities are greater than an intensity threshold may be determined from the point cloud data based on the reflection intensity of each of points in the point cloud data; a plurality of point clouds may be obtained by segmenting the set of points of which the reflection intensities are greater than the intensity threshold; a straight line may be extracted based on M adjacent point clouds in the plurality of point clouds; if the straight line is extracted, the location information of the target in the laser coordinate system may be determined based on the equation of the extracted straight line. If the reflection intensities of the at least two first reflection regions are greater than the reflection intensity of the at least one second reflection region, M may be 3. If the reflection intensities of the at least two first reflection regions are less than the reflection intensity of the at least one second reflection region, M may be 2.

Merely by way of example, when the at least two first reflection regions are low reflection regions and the at least one second reflection region is a high reflection region, the operation of extracting the straight line based on the M adjacent point clouds of the plurality of point clouds may include: determining two adjacent point clouds as point clouds of two second reflection regions, determining three point clouds separated by the two adjacent point clouds as point clouds of three first reflection regions, and extracting the straight line based on the point clouds of the three first reflection regions. In order to extract the straight line through the point clouds of the three first reflection regions, if a count of points in the point clouds of the at least two first reflection regions located on two sides is too large, a preset count of points that are adjacent to the point clouds of the at least one second reflection region may be extracted from the point clouds of the at least two first reflection regions located on the two sides to perform extraction of the straight line in combination with the point clouds of the at least two first reflection regions located in the middle.

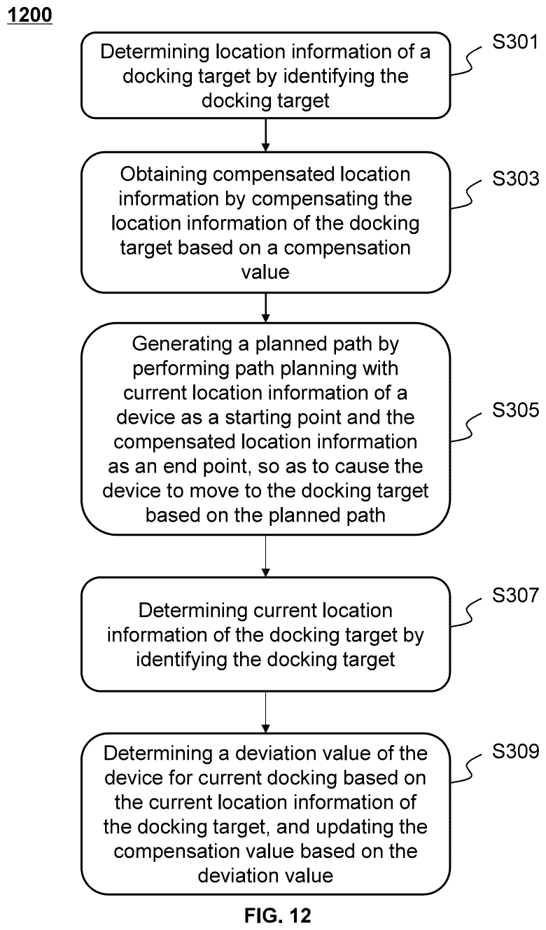

FIG. 12 is a flowchart illustrating an exemplary process for device docking according to some embodiments of the present disclosure. In some embodiments, the process 1200 may be implemented in the system 100 illustrated in FIG. 1. For example, the process 1200 may be stored in a storage medium (e.g., the storage device 140, a storage 11 illustrated in FIG. 14, etc.) as a form of instructions, and can be invoked and/or executed by a processing device (e.g., the processor 120, a processor 12 illustrated in FIG. 14, or one or more modules illustrated in FIG. 10). The operations of the illustrated process 1200 presented below are intended to be illustrative. In some embodiments, the process 1200 may be accomplished with one or more additional operations not described, and/or without one or more of the operations discussed. Additionally, the order in which the operations of the process 1200 as illustrated in FIG. 12 and described below is not intended to be limiting. In some embodiments, the process 1200 may be performed by the device 111, the processor 120, or the terminal device 130. For the purpose of illustration, in the following descriptions, the process 1200 performed by the processor 120 is described as an example.

In S301, the processor 120 may determine location information of a docking target by identifying the docking target.

The location information of the docking target may be determined by identifying the docking target, so that a planned path may be generated by performing path planning with the current location information of the laser scanning device as a starting point and the location information of the docking target as an end point. A device (e.g., the device 111) may be controlled to move to the docking target based on the planned path.

The at least two first reflection regions and the at least one second reflection region may be provided on the docking target, so that the location information of the docking target may be determined by the method for locating the target described above.

In some embodiments, the location information of the docking target may be determined by the method for locating the target described in FIG. 2 and/or operations S202-S204.

In some embodiments, the location information of the docking target may be determined by the method for locating the target described in FIG. 5 and/or operations S205-S208 in which the distance is greater than the distance threshold.

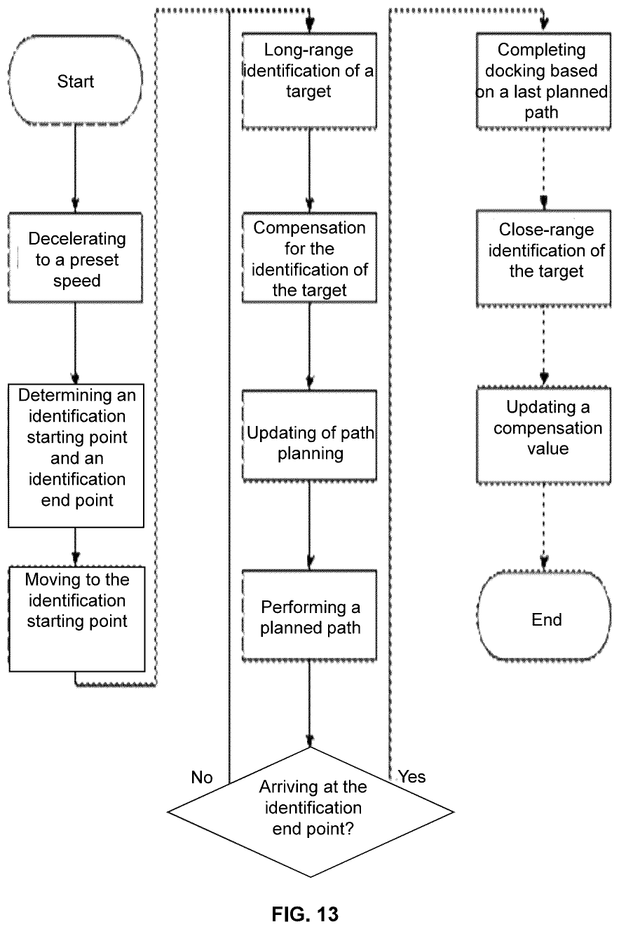

FIG. 13 is a flowchart illustrating an exemplary process for device docking according to some embodiments of the present disclosure. Optionally, as shown in FIG. 8 and FIG. 13, a processor 120 may determine an identification starting point and an identification end point. When a device is located between the identification starting point and the identification end point, location information of a docking target may be determined by performing the operation S301, so that the location information of the docking target may be more accurately identified through an identification interval with a relatively high identification accuracy including the identification starting point and the identification end point, thereby improving the accuracy of a planned path generated based on the location information of the docking target, so that the device may arrive at the docking target more accurately. Due to the insufficient identification accuracy of the docking target when the device does not arrive at the identification starting point, docking errors caused by target location information identification and path planning when the device does not arrive at the identification starting point may be avoided; and when the device exceeds the identification end point, a generated path may not be executed due to a proximity to the docking target, so that unnecessary operations of identification and path planning for the docking target may be reduced through the above features, thereby saving computational resources. The identification starting point and the identification end point may be related to the docking target. Specifically, the identification starting point and the identification end point may be determined based on the location information of the docking target. Further, the identification starting point and the identification end point may be determined based on a distance from the docking target. The device may move based on a preset docking path in advance when the device is docked with the docking target, and determine the identification starting point and the identification end point based on the docking target on the preset docking path.

The docking target is not limited, and may include, for example, a storage location or a workstation, etc. In addition, the device may perform docking of the docking target multiple times utilizing the method for device docking of the present embodiments. The docking target of the device is set each time based on a task of the device each time, such that the docking target of the device at different times may be the same or different.

In S303, the processor 120 may obtain compensated location information by compensating the location information of the docking target based on a compensation value.

After determining the location information of the docking target is determined based on the operation S301, the compensated location information may be obtained by compensating the location information of the docking target based on the compensation value, so that a planned path may be generated by performing path planning subsequently with the current location information of the device as the starting point and the compensated location information as the end point, and the device may be controlled to move to the docking target based on the planned path.

The compensation value may be a preset compensation value at the time of initial power-up of the device, i.e., at the first time the device is docked with the docking target utilizing the method for device docking of the present embodiment. At the nth time the device is docked with the docking target utilizing the method for device docking of the present embodiment, the compensation value may be updated based on a docking result of (n−1)th docking utilizing the method for device docking of the present embodiment, wherein n is greater than or equal to 2. In this case, the method for updating the compensation value allows updating the compensation value after each docking is completed utilizing the docking result of the current docking, so that a deviation value observed after the docking is completed can be used for the next docking to improve the accuracy, thereby improving the docking accuracy.

In S305, the processor 120 may generate a planned path by performing path planning with a current location information of a device as a starting point and the compensated location information as an end point, so as to cause the device to move to the docking target based on the planned path.

After the compensated location information of the docking target is determined, the planned path may be generated by performing path planning with the current location information of the device as the starting point and the compensated location information as the end point, so as to cause the device to move to the docking target based on the planned path.

After the planned path is generated by performing path planning with the current location information of the device as the starting point and the compensated location information as the end point, the planned path be sent to a movement control model of the equipment for execution to cause the device to move based on the planned path.

For the convenience of path planning, when the location information of the docking target obtained in S301 is not in the map coordinate system, the docking target may be projected to the map coordinate system to obtain the location information of the docking target in the map coordinate system.

In some embodiments, the docking target may be projected to the map coordinate system before S303. For example, assuming that S301 obtains location information

$${T}_{f\_far}^{L} = [ {x}_{f\_far}^{L} , {y}_{f\_far}^{L} , {θ}_{f\_far}^{L} ]$$

of the docking target in the laser coordinate system, an identified target may be projected to the map coordinate system

$${T}_{f\_far}^{M} = {T}_{B}^{M} \cdot {T}_{L}^{B} \cdot {T}_{f\_far}^{L}$$

based on location information

$${T}_{B}^{M}$$

of the device in a map provided by an identification time localization module and a mounting external parameter

$${T}_{L}^{B}$$

of a device laser.

In some embodiments, the docking target may be projected to the map coordinate system after S303. For example, assuming that S301 obtains location information

$${T}_{f \_ far}^{L} = [ {x}_{f \_ far}^{L} , {y}_{f \_ far}^{L} , {θ}_{f \_ far}^{L} ]$$

of the docking target in the laser coordinate system, compensated location information

$${T}_{f \_ far}^{L ′} = ∈ \cdot {T}_{f \_ far}^{L}$$

may be obtained by compensating the location information of the docking target in the laser coordinate system, and the compensated location information may be projected to the map coordinate system

$${T}_{f \_ far}^{M ′} = {T}_{B}^{M} \cdot {T}_{L}^{B} \cdot ∈ \cdot {T}_{f \_ far}^{L}$$

based on the location information

$${T}_{B}^{M}$$

of the device in the map provided by an identification time localization module and the mounting external parameter

$${T}_{L}^{B}$$

of the device laser.

In some embodiments, coordinate system conversion may not be performed for the location information of the docking target.

In some embodiments, the operations S301, S303, and S305 may be performed sequentially at a set frequency until the device moves to the docking target. Further, when the device is located between the identification starting point and the identification end point, the operations S301, S303, S305 may be performed sequentially at the set frequency, i.e., the operations S301, S303, S305 may be performed sequentially at a preset time period. That is, after all of the operations S301, S303, and S305 are performed once, the operations S301, S303, and S305 may be performed again at the preset time period, and so on repeatedly until the device moves to the target docking. In addition, when the device sequentially performs the operations S301, S303, and S305 at the set frequency, if the device moves beyond the identification end point, the device does not need to perform the operations S301, S303, and the operation that the planned path is generated by performing path planning with the current location information of the device as the starting point and the compensated location information as the end point. The device may move to the end point based on a last planned path.

In S307, the processor 120 may determine the current location information of the docking target by identifying the docking target.

After the device is controlled to move to the docking target based on the above operations and complete the docking, the current location information of the docking target may be determined by identifying the docking target again, so as to subsequently determine a deviation value for the current docking based on the current location information. Accordingly, the compensation value may be updated based on the deviation value for the current docking, the deviation value observed after the docking is completed may be used for the next docking to improve the accuracy, thereby improving the docking accuracy.

In order to improve the identification accuracy, the current location information of the docking target may be identified utilizing the method for locating the target described in the first embodiment. In this way, the docking target at a close range may be identified based on an angle with a relatively high accuracy, which can improve the identification accuracy of the docking target, the deviation value for the current docking can be determined relatively accurately to improve the compensation effect for the next docking, thereby gradually improving the docking accuracy.

In S309, the processor 120 may determine a deviation value of the device for current docking based on the current location information, and the compensation value may be updated based on the deviation value.

After determining the current location information of the docking target is determined based on the operation S307, the deviation value of the device for the current docking may be determined based on the current location information of the docking target, and the compensation value may be updated based on the deviation value.

In some embodiments, a relative location information relationship

$${T}_{f \_ gt}^{B}$$

between the docking target and the device in case of no error in an ideal state may be preset, and the deviation value of the device for the current docking may be calculated based on the preset relative location information relationship and the current location information of the docking target. The preset relative location information relationship may be set at a docking storage location based on a size of the device, a workstation/target position, etc.

In addition, in order to minimize the effect of the way the laser is set up on the calculation of the deviation value, the current location information

$${T}_{f \_ close}^{L}$$

of the docking target may be converted to a vehicle coordinate system after the current location information

$${T}_{f \_ close}^{L}$$

of the downing target is calculated in the operation S307. Merely by way of example, the current location information

$${T}_{f \_ close}^{L}$$

of the docking target be converted to the vehicle coordinate system by a formula

$${T}_{f \_ close}^{B} = {T}_{L}^{B} \cdot {T}_{f \_ close}^{L}$$

to obtain the location information

$${T}_{f \_ close}^{B}$$

of the docking target in the vehicle coordinate system. In this way, a deviation value h of the device for the current docking may be calculated based on a formula

$$h = {T}_{f \_ gt}^{B} \cdot {( {T}_{f \_ close}^{B} )}^{- 1} .$$

After the deviation value of the device for the current docking is calculated, the compensation value may be updated based on the deviation value of the device for the current docking.

In some embodiments, the deviation value of the device for the current docking may be used directly for storage location compensation of next docking, i.e., the calculated deviation value of the device for the current docking may be used as a latest compensation value.

In some embodiments, a mean value of the deviation value of the device for the current docking and the deviation values of the device for the previous N−1 dockings may be obtained, and the obtained mean value may be used as the latest compensation value.

In some embodiments, a median value of the deviation value of the device for the current docking and the deviation values of the device for the previous N−1 dockings may be used as the latest compensation value.

Referring to FIG. 14, FIG. 14 is a structural schematic diagram illustrating an exemplary electronic device according to some embodiments of the present disclosure. An electronic device 10 may include a processor 12 configured to execute instructions for realizing the method for locating the target and the method for device docking as described in any of the above embodiments. The specific implementation process is described in the description of the above embodiments and is not repeated here.

The processor 12 is also be referred to as a Central Processing Unit (CPU). The processor 12 may be an integrated circuit chip with signal processing capabilities. The processor 12 may also be a general-purpose processor, a digital signal processor (DSP), an application-specific integrated circuit (ASIC), a field-programmable gate array (FPGA) or another programmable logic device, a discrete gate or transistor logic device, or a discrete hardware component. The general-purpose processor may be a microprocessor or the processor 12 may be any conventional processor, or the like.

The electronic device 10 may further include a storage 11 configured to store instructions and data required for operation of the processor 12.

The electronic device 10 may be implemented on the processor 120, the device 111, and/or the terminal device 130.

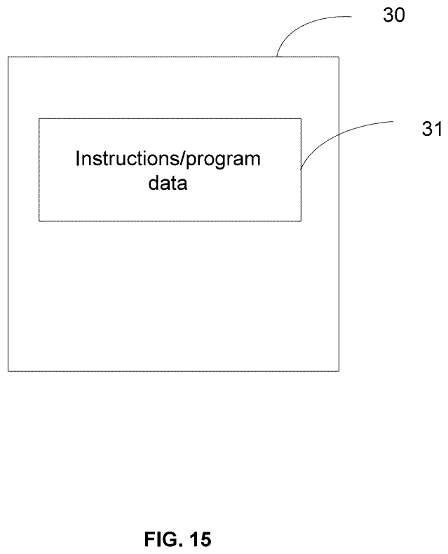

Referring to FIG. 15, FIG. 15 is a structural schematic diagram illustrating a non-transitory computer readable storage medium according to some embodiments of the present disclosure. A non-transitory computer-readable storage medium 30 of the embodiments of the present disclosure may be configured to store instructions/program data 31 that, when executed, may implement the method for locating the target (e.g., the process 200, the process 500, and/or the process 1100) and the method for device docking (e.g., the process 700 and/or the process 1200) as described in any embodiment of the present disclosure. The instructions/program data 31 may form program files to be stored in the storage medium 30 in the form of software products to cause a computer device (which may be a personal computer, a server, or a network device, etc.) or a processor to perform all or a portion of the operations of the method of the various embodiments of the present disclosure. The storage medium 30 may include: a USB flash drive, a mobile hard disk, a read-only memory (ROM), a random access memory (RAM), a disk or a CD-ROM, and other kinds of media that can store program codes, or a terminal device such as a computer, a server, a mobile phone, a tablet, etc.

The basic concept has been described above. Obviously, for those skilled in the art, the above detailed disclosure is only an example, and does not constitute a limitation to the present disclosure. Although not expressly stated here, those skilled in the art may make various modifications, improvements and corrections to the present disclosure. Such modifications, improvements and corrections are suggested in this disclosure, so such modifications, improvements and corrections still belong to the spirit and scope of the exemplary embodiments of the present disclosure.

Meanwhile, the present disclosure uses specific words to describe the embodiments of the present disclosure. For example, “one embodiment”, “an embodiment”, and/or “some embodiments” refer to a certain feature, structure or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures or characteristics in one or more embodiments of the present disclosure may be properly combined.

In addition, unless clearly stated in the claims, the sequence of processing elements and sequences described in the present disclosure, the use of counts and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in this disclosure and help the understanding of one or more embodiments of the invention, in the foregoing description of the embodiments of the present disclosure, sometimes multiple features are combined into one embodiment, drawings or descriptions thereof. This method of disclosure does not, however, imply that the subject matter of the disclosure requires more features than are recited in the claims. Rather, claimed subject matter may lie in less than all features of a single foregoing disclosed embodiment.

In some embodiments, counts describing the quantity of components and attributes are used. It should be understood that such counts used in the description of the embodiments use the modifiers “about”, “approximately” or “substantially” in some examples. Unless otherwise stated, “about”, “approximately” or “substantially” indicates that the stated figure allows for a variation of ±20%. Accordingly, in some embodiments, the numerical parameters used in the disclosure and claims are approximations that can vary depending upon the desired characteristics of individual embodiments. In some embodiments, numerical parameters should consider the specified significant digits and adopt the general digit retention method. Although the numerical ranges and parameters used in some embodiments of the present disclosure to confirm the breadth of the range are approximations, in specific embodiments, such numerical values are set as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A method for locating a target implemented on a device including at least one processing device and at least one storage device, wherein the target includes at least three reflection regions, the at least three reflection regions include at least two first reflection regions distributed at intervals and at least one second reflection region, a region between every two adjacent first reflection regions of the at least two first reflection regions is the second reflection region, and reflective properties of the at least two first reflection regions are different from a reflective property of the at least one second reflection region, the method comprising:
obtaining first point cloud data generated by scanning the target by a laser scanning device, the first point cloud data including a plurality of first data points;
determining, based on reflection intensities of the plurality of first data points, point clouds of at least three first target reflection regions of the at least three reflection regions from the first point cloud data;
determining, based on the point clouds of the at least three first target reflection regions, a laser reflection angle of each of the at least three first target reflection regions; and
determining, based on the laser reflection angle of each of the at least three first target reflection regions, first location information of the target.

2. The method of claim 1, wherein the at least three first target reflection regions include at least three first reflection regions.

3. The method of claim 1, wherein determining, based on the laser reflection angle of each of the at least three first target reflection regions, the first location information of the target includes:
determining, based on the laser reflection angle of each of the at least three first target reflection regions, an angle difference between the laser reflection angles of every two adjacent first target reflection regions; and
determining, based on the angle difference and a distance between every two adjacent first target reflection regions, the first location information of the target.

4. The method of claim 1, wherein determining, based on reflection intensities of the plurality of first data points, the point clouds of the at least three first target reflection regions of the at least three reflection regions from the first point cloud data includes:
obtaining an intensity threshold;
determining, based on the intensity threshold and the reflection intensities of the plurality of first data points, at least one first candidate point set and/or at least one second candidate point set from the first point cloud data, the at least one first candidate point set being related to the at least two first reflection regions, and the at least one second candidate point set being related to the at least one second reflection region; and
determining, based on the at least one first candidate point set and/or the at least one second candidate point set, the point clouds of the at least three first target reflection regions.

5. The method of claim 4, further comprising:
in response to determining that a count of the at least one first candidate point set is not equal to a count of the at least two first reflection regions, and/or a count of the at least one second candidate point set is not equal to a count of the at least one second reflection region, determining, based on a preset distance range and/or a preset angle range, the point clouds of the at least three first target reflection regions from the at least one first candidate point set and/or the at least one second candidate point set.

6. The method of claim 1, further comprising:
in response to determining that a distance between the target and the laser scanning device is less than a first distance threshold, performing the method of claim 1.

7. The method of claim 6, further comprising:
in response to determining that the distance between the target and the laser scanning device is greater than or equal to the first distance threshold:
obtaining second point cloud data generated by scanning the target by the laser scanning device, the second point cloud data including a plurality of second data points;
determining, based on reflection intensities of the plurality of second data points, a point cloud of at least one second target reflection region of the at least three reflection regions from the second point cloud data; and
determining, based on coordinates of at least a portion of the second data points in the point cloud of the at least one second target reflection region, second location information of the target.

8. The method of claim 7, wherein
the at least two first reflection regions are with a greater width than the at least one second reflection region, and the at least one second target reflection region includes the at least two first reflection regions; or
the at least two first reflection regions are with a smaller width than the at least one second reflection region, and the at least one second target reflection region includes the at least one second reflection region.

9. The method of claim 7, wherein determining, based on the coordinates of at least a portion of the second data points in the point cloud of the at least one second target reflection region, the second location information of the target includes:
determining, based on the coordinates of at least a portion of the second data points in the point cloud of the at least one second target reflection region, a straight line; and
determining, based on the straight line, the second location information of the target.

10. The method of claim 9, wherein determining, based on the straight line, the second location information of the target includes:
determining a set of projection points by projecting at least a portion of the second data points in the point clouds of the at least three reflection regions of the target onto the straight line; and
determining, based on coordinates of the projection points in the set of projection points and the straight line, the second location information.

11. The method of claim 10, wherein determining the set of projection points by projecting at least a portion of the second data points in the point clouds of the at least three reflection regions of the target onto the straight line includes:
determining the set of projection points by projecting the second data points corresponding to a middle position of the target onto the straight line.

12. The method of claim 10, wherein determining, based on the coordinates of the projection points in the set of projection points and the straight line, the second location information includes:
determining a mean value of x-components of the coordinates of the projection points in the set of projection points as an x-component of the second location information;
determining a mean value of y-components of the coordinates of the projection points in the set of projection points as a y-component of the second location information; and
determining, based on an x-coefficient and a y-coefficient in an equation of the straight line, a yaw angle of the second location information.

13. The method of claim 9, wherein determining, based on the straight line, the second location information of the target includes:
in response to determining that at least two straight lines are extracted, determining estimated location information corresponding to each of the at least two straight lines; and
determining, among the estimated location information corresponding to the at least two straight lines, the estimated location information closest to the laser scanning device in a target direction as the second location information of the target, the target direction being a direction perpendicular to a movement direction of the laser scanning device in a laser coordinate system.

14. A method for device docking implemented on a device including at least one processing device and at least one storage device, comprising:
controlling a device to move to a target position for docking, including:
determining initial location information of a target;
determining compensated location information by adjusting, based on a compensation value, the initial location information;
determining a docking position based on the compensated location information;
generating a planned path with a current position of the device as a starting point and the docking position as an end point; and
controlling the device to move based on the planned path.

15. The method of claim 14, further comprising:
determining an identification starting point and an identification end point;
in response to determining that the device is located between the identification starting point and the identification end point, performing the method of claim 14 at a preset frequency; or
in response to determining that the device is located between the identification end point and the target,
determining the docking position corresponding to the last planned path as the target position, and
controlling the device to move, based on the last planned path, to the target position.

16. The method of claim 14, further comprising:
after the device reaches the target position,
obtaining first point cloud data generated by scanning the target by a laser scanning device of the device, the first point cloud data including a plurality of first data points, wherein
the target includes at least three reflection regions, the at least three reflection regions include at least two first reflection regions distributed at intervals and at least one second reflection region, a region between every two adjacent first reflection regions is the second reflection region, and reflective properties of the at least two first reflection regions are different from a reflective property of the at least one second reflection region;
determining, based on reflection intensities of the plurality of first data points, point clouds of at least three first target reflection regions of the at least three reflection regions from the first point cloud data;
determining, based on the point clouds of the at least three first target reflection regions, a laser reflection angle of each of the at least three first target reflection regions;
determining, based on the laser reflection angle of each of the at least three first target reflection regions, first location information of the target;
determining, based on the first location information, a deviation value of the device for current docking; and
updating, based on the deviation value, the compensation value.

17. The method of claim 16, wherein updating, based on the deviation value, the compensation value includes:
updating the compensation value to the deviation value of the device for the current docking.

18. The method of claim 16, wherein updating, based on the deviation value, the compensation value includes:
determining a mean value or a median value of the deviation values of the current docking and at least one previous docking of the device; and
updating the compensation value to the mean value or the median value.

19. (canceled)

20. A system for locating a target, wherein the target includes at least three reflection regions, the at least three reflection regions include at least two first reflection regions distributed at intervals and at least one second reflection region, a region between every two adjacent first reflection regions of the at least two first reflection regions is the second reflection region, and reflective properties of the at least two first reflection regions are different from a reflective property of the at least one second reflection region, the system comprising:
at least one storage device including a set of instructions; and
at least one processor in communication with the at least one storage device, wherein when executing the set of instructions, the at least one processor is directed to perform operations including:
obtaining first point cloud data generated by scanning the target by a laser scanning device, the first point cloud data including a plurality of first data points;
determining, based on reflection intensities of the plurality of first data points, point clouds of at least three first target reflection regions of the at least three reflection regions from the first point cloud data;
determining, based on the point clouds of the at least three first target reflection regions, a laser reflection angle of each of the at least three first target reflection regions; and
determining, based on the laser reflection angle of each of the at least three first target reflection regions, first location information of the target.

21-24. (canceled)

25. The system of claim 20, wherein determining, based on the laser reflection angle of each of the at least three first target reflection regions, the first location information of the target includes:
determining, based on the laser reflection angle of each of the at least three first target reflection regions, an angle difference between the laser reflection angles of every two adjacent first target reflection regions; and
determining, based on the angle difference and a distance between every two adjacent first target reflection regions, the first location information of the target.
